(19) United States
(12) Patent Application Publication
(10) Pub. No.: US 2023/0242765 A1
(43) Pub. Date: Aug. 3, 2023

(54) POLYORGANO SILSESQUIOXANE, CURABLE COMPOSITION, CURED PRODUCT, HARD COAT FILM, ADHESIVE SHEET, AND LAMINATE

(71) Applicant: DAICEL CORPORATION, Osaka-shi, Osaka (JP)

(72) Inventors: Nobuhiro KAWAHARA, Tokyo (JP); Tomoko ADACHI, Tokyo (JP); Akihiro SHIBAMOTO, Tokyo (JP); Shinji MAETANI, Tokyo (JP)

(73) Assignee: DAICEL CORPORATION, Osaka-shi, Osaka (JP)

(21) Appl. No.: 18/018,904

(22) PCT Filed: Aug. 19, 2021
(86) PCT No.: PCT/JP2021/030424

§ 371 Date: Jan. 31, 2023

(30) Foreign Application Priority Data
Aug. 28, 2020 (JP) 2020-145083

(51) Int. Cl. C08L 83/06; C08J 7/04; C09D 183/06; C09J 183/06

(52) U.S. Cl. CPC C08L 83/06; C08J 7/0427; C09D 183/06; C09J 183/06; C08J 2383/06

(57) ABSTRACT

Provided is a polyorganosilsesquioxane that is suitable as a material for a hard coat film or an adhesive, the polyorganosilsesquioxane being capable of forming a cured product having a high surface hardness and flexibility while having a high heat resistance or the like. The polyorganosilsesquioxane contains a cage-type silsesquioxane represented by Compositional Formula (1). When the polyorganosilsesquioxane is analyzed using a liquid chromatography-evaporative light scattering detector, a peak area % of the cage-type silsesquioxane represented by Compositional Formula (1) is 5% or greater with respect to a peak area of all components detected.

[R¹SiO_{3/2}]₈[R¹SiO_{2/2}(OR^{c})]₁ Formula (1)

### TECHNICAL FIELD

The present disclosure relates to a polyorganosilsesquioxane, a curable composition containing the polyorganosilsesquioxane and a cured product of the curable composition, and a hard coat film made of the cured product. The present disclosure further relates to a composition (composition for an adhesive) containing the polyorganosilsesquioxane, as well as an adhesive sheet and a laminate each prepared using the composition. The present application claims priority to Japanese Patent Application No. 2020-145083, filed in Japan on Aug. 28, 2020, the contents of which are incorporated herein by reference.

### BACKGROUND ART

Polyorganosilsesquioxanes (silsesquioxanes) are network polymers or polyhedral clusters obtained by hydrolyzing trifunctional silanes. Known types of polyorganosilsesquioxanes include cage-type silsesquioxanes as well as random-type and ladder-type silsesquioxanes. A cage-type silsesquioxane is a general term for a substance having a three-dimensional closed-loop structure formed by a siloxane bond, with a silica cubic structure at the center and an organic functional group located at each vertex of the cubic structure. The cubic structure mainly includes silsesquioxane octamer (T₈) that has a regular hexahedral structure and silsesquioxane decamer (T₁₀) that has an augmented pentagonal prism structure. Also, the cage-type silsesquioxane can be used to produce a cured product having excellent heat resistance, weather resistance, optical properties, dimensional stability, and the like; many studies have been made on cage-type silsesquioxanes. Such cage-type silsesquioxanes are described, for example, in Patent Documents 1 to 3 listed below.

### CITATION LIST

### Patent Document

Patent Document 1: JP 2000-334881 A
Patent Document 2: JP 2010-18664 A
Patent Document 3: JP 2014-101435 A

### SUMMARY OF INVENTION

### Technical Problem

However, the cured product produced from a cage-type silsesquioxane described thus far tends to lack sufficient hardness. Therefore, such a cage-type silsesquioxane may not be usable as a material for hard coating in applications requiring a high hardness, and the use of the cage-type silsesquioxane as a material for hard coating is limited. In addition, a hard coat film having a hard coat layer in which a typical UV-curable acrylic monomer is used has a pencil hardness of around 2H. Therefore, such a hard coat film is not yet considered to have sufficient surface hardness.

In general, possible solutions to achieve higher hardness include using a multifunctional UV-curable acrylic monomer as the UV-curable acrylic monomer and/or increasing the thickness of the hard coat layer. However, these solutions cause the hard coat layer to undergo greater cure shrinkage, which in turn may result in poor flexibility of the hard coat layer or cracks in the hard coat layer.

Therefore, an object of the invention of the present disclosure is to provide a polyorganosilsesquioxane that is suitable as a material for a hard coat film, the polyorganosilsesquioxane being capable of forming a hard coat layer that is a cured product having a high surface hardness and flexibility while having a high heat resistance which is characteristic of a cage-type silsesquioxane.

Another object of the invention of the present disclosure is to provide a curable composition containing the polyorganosilsesquioxane.

Furthermore, another object of the invention of the present disclosure is to provide a cured product of the curable composition and a hard coat film having a hard coat layer that is the cured product of the curable composition.

Furthermore, another object of the invention of the present disclosure is to provide a composition for an adhesive (adhesive) capable of forming a cured product (adhesive member) having a high heat resistance and excellent flexibility, as well as an adhesive sheet and a laminate each prepared using the composition for an adhesive (adhesive).

### Solution to Problem

The inventors of the present disclosure found that, by using a polyorganosilsesquioxane containing a certain proportion or more of a cage silsesquioxane structure having a specific compositional formula, a cured product of a curable composition containing the polyorganosilsesquioxane offers excellent surface hardness and flexibility and is very useful as a hard coat layer in a hard coat film. Furthermore, the inventors of the present disclosure found that the curable composition containing the polyorganosilsesquioxane is advantageously usable as a composition for an adhesive (adhesive) that forms a cured product (adhesive member) having a high heat resistance and excellent flexibility. The present disclosure has been completed based on these findings.

That is, the present disclosure provides a polyorganosilsesquioxane containing a cage-type silsesquioxane represented by Compositional Formula (1) below (T₉), in which, when the polyorganosilsesquioxane is analyzed using a liquid chromatography-evaporative light scattering detector, a peak area % of the T₉ is 5% or greater with respect to a peak area of all components.

[R¹SiO_{3/2}]₈[R¹SiO_{2/2}(OR^{c})]₁ Formula (1):

where in Formula (1), each R¹ is independently a group containing a polymerizable functional group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom, while at least one R¹ is a group containing a polymerizable functional group; R^{c} represents an alkyl group having from 1 to 4 carbons or a hydrogen atom.

The present disclosure also provides the polyorganosilsesquioxane in which the group containing a polymerizable functional group is:
a group represented by the following Formula (1a)

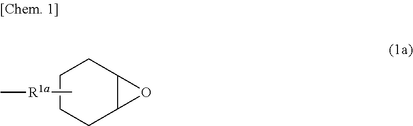

where R^{1a} represents a linear or branched alkylene group;

a group represented by the following Formula (1b)

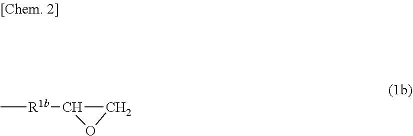

where R^{1b} represents a linear or branched alkylene group;

a group represented by the following Formula (1c)

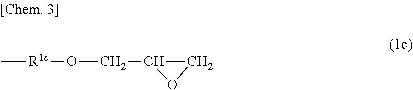

where R^{1c} represents a linear or branched alkylene group; or a group represented by the following Formula (1d)

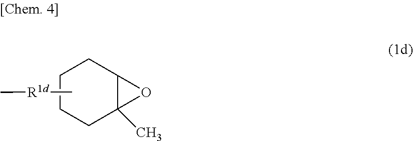

where R^{1d} represents a linear or branched alkylene group.

The present disclosure also provides the polyorganosilsesquioxane in which the proportion of the group containing a polymerizable functional group to the total of R¹ in the cage-type silsesquioxane represented by Compositional Formula (1) above is 30% or greater.

The present disclosure also provides the polyorganosilsesquioxane in which a molar ratio of constituent units represented by the following Formula (I) to constituent units represented by the following Formula (II) [constituent units represented by Formula (I)/constituent units represented by Formula (II)] is from 1 to 500,

[R^{a}SiO_{3/2}] (I)

where in Formula (I), R^{a} represents a group containing a polymerizable functional group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom,

[R^{b}SiO_{2/2}(OR^{c})] (II)

where in Formula (II), R^{b} represents a group containing a polymerizable functional group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom; R^{c} represents a hydrogen atom or an alkyl group having from 1 to 4 carbons.

The present disclosure also provides the polyorganosilsesquioxane having a number average molecular weight from 1000 to 50000.

The present disclosure also provides the polyorganosilsesquioxane in which a polydispersity index (weight average molecular weight/number average molecular weight) is from 1.0 to 4.0.

The present disclosure also provides the polyorganosilsesquioxane in which a 5% weight loss temperature (T₈) is 330° C. or higher.

The present disclosure also provides a curable composition containing the polyorganosilsesquioxane.

Also, the present disclosure further provides the curable composition containing a curing catalyst.

The present disclosure also provides the curable composition in which the curing catalyst is a photopolymerization initiator or a thermal polymerization initiator.

The present disclosure also provides the curable composition that is a curable composition for forming hard coat layer.

The present disclosure further provides the curable composition that is a composition for an adhesive.

The present disclosure also provides a cured product of the curable composition.

The present disclosure also provides a hard coat film in which a base material and a hard coat layer formed on at least one surface of the base material are laminated, the hard coat layer being a cured product of the curable composition.

The present disclosure also provides an adhesive sheet having a base material and an adhesive layer on the base material, the adhesive layer being a layer of the curable composition.

The present disclosure also provides a laminate having three or more layers which include two adherend layers and an adhesive layer between the two adherend layers, the adhesive layer being a layer of a cured product of the curable composition.

### Advantageous Effects of Invention

The hard coat layer, which is a cured product produced from the polyorganosilsesquioxane according to an embodiment of the present disclosure, has a high surface hardness and flexibility while having a high heat resistance which is characteristic of a cage-type silsesquioxane. As such, a molded product (product) having a high surface hardness and flexibility can be produced by using a hard coat film having the hard coat layer. In addition, the hard coat film containing the polyorganosilsesquioxane according to an embodiment of the present disclosure has excellent flexibility. Accordingly, the hard coat film can be handled after being wound into a roll, and the film containing the hard coat layer can be handled in a roll-to-roll process; as such, the hard coat film containing the polyorganosilsesquioxane according to an embodiment of the present disclosure offers excellent performance in terms of both quality and cost. Furthermore, the curable composition containing the polyorganosilsesquioxane according to an embodiment of the present disclosure as an essential component is advantageously usable as a composition for an adhesive (adhesive) that forms a cured product (adhesive member) having a high heat resistance and excellent flexibility. Using the adhesive composition can produce the adhesive sheet and the laminate.

### BRIEF DESCRIPTION OF DRAWINGS

FIG. 1 is a ¹H-NMR chart of a product (polyorganosilsesquioxane) obtained in Example 1.

FIG. 2 is a ²⁹Si-NMR chart of the product (polyorganosilsesquioxane) obtained in Example 1.

FIG. 3 is an HPLC-ELSD chromatogram of the product (polyorganosilsesquioxane) obtained in Example 1.

FIG. 4 is the results of mass spectrometry of a fraction obtained in Example 1.

FIG. 5 is a theoretical isotope pattern of the compositional formula C₇₂H₁₂₂NO₂₃Si₉.

FIG. 6 is a schematic view (cross-sectional view) illustrating a hard coat film of an embodiment of the present disclosure.

FIG. 7 is a schematic view (cross-sectional view) illustrating an adhesive sheet of an embodiment of the present disclosure.

FIG. 8 is a schematic view (cross-sectional view) illustrating a laminate of an embodiment of the present disclosure.

### DESCRIPTION OF EMBODIMENTS

### [Polyorganosilsesquioxane]

The polyorganosilsesquioxane according to an embodiment of the present disclosure contains a cage-type silsesquioxane represented by Compositional Formula (1) below (which may be simply referred to as “T₉” hereinafter), and when the polyorganosilsesquioxane is analyzed using a liquid chromatography-evaporative light scattering detector (LC-ELSD), a peak area % of the T₉ is 5% or greater (preferably 6% or greater, more preferably 7% or greater, more preferably 8% or greater, more preferably 9% or greater, more preferably 10% or greater, more preferably 12% or greater, more preferably 14% or greater, more preferably 16% or greater, more preferably 18% or greater, more preferably 20% or greater, more preferably 22% or greater, more preferably 24% or greater, more preferably 26% or greater, more preferably 28% or greater, more preferably 30% or greater, more preferably 32% or greater, more preferably 34% or greater, more preferably 36% or greater, more preferably 38% or greater, more preferably 40% or greater, and even more preferably 45% or greater) with respect to a peak area of all components. When the ratio is 5% or greater, the proportion of T₉ in the polyorganosilsesquioxane according to an embodiment of the present disclosure is large, and the surface hardness of a cured product of the polyorganosilsesquioxane according to an embodiment of the present disclosure further improve. The peak area % of T₉, although not limited, is preferably 90% or less, more preferably 80% or less.

[R¹SiO_{3/2}]₈[R¹SiO_{2/2}(OR^{c})]₁ Formula (1):

In Compositional Formula (1), each R¹ is independently a group containing a polymerizable functional group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom, while at least one R¹ is a group containing a polymerizable functional group. R^{c} in Compositional Formula (1) is a hydrogen atom or an alkyl group having from 1 to 4 carbons.

Furthermore, in the polyorganosilsesquioxane according to an embodiment of the present disclosure, when the polyorganosilsesquioxane is analyzed using a liquid chromatography-evaporative light scattering detector (LC-ELSD), a ratio the peak area % of the cage-type silsesquioxane represented by Compositional Formula (1) above (T₉) to a peak area % of a cage-type silsesquioxane having a constituent unit represented by Compositional Formula (I-2) below (which may be simply referred to as “T₁₀” hereinafter), that is, T₉/T₁₀, is not limited, but is preferably 0.4 or greater, more preferably 0.5 or greater, more preferably 0.6 or greater, more preferably 0.7 or greater, more preferably 0.8 or greater, more preferably 0.9 or greater, more preferably 1 or greater, more preferably 1.2 or greater, more preferably 1.4 or greater, more preferably 1.6 or greater, more preferably 1.8 or greater, more preferably 2 or greater, more preferably 2.2 or greater, more preferably 2.4 or greater, more preferably 2.6 or greater, more preferably 2.8 or greater, more preferably 3 or greater, more preferably 3.5 or greater, more preferably 4 or greater, more preferably 4.5 or greater, and even more preferably 5 or greater. When the peak area % of T₉ is 5% or greater and the ratio of T₉/T₁₀ is 0.4 or greater, the proportion of T₉ in the polyorganosilsesquioxane according to an embodiment of the present disclosure becomes correspondingly large, and both the surface hardness and flexibility of the cured product of the polyorganosilsesquioxane according to an embodiment of the present disclosure readily improve. The ratio of T₉/T₁₀ is, although not limited, preferably 10 or less, more preferably 9 or less.

[R^{a}SiO_{3/2}]₁₀ (I-2)

In Compositional Formula (I-2) above, R^{a} represents a group containing a polymerizable functional group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom.

The peak area % detected using a liquid chromatography-evaporative light scattering detector (LC-ELSD) described above can be measured, for example, by a method described in Examples below.

A constituent unit represented by Formula (I) below (which may be referred to as a “T3 unit” in this specification hereinafter) includes the constituent unit represented by [R¹SiO_{3/2}] in Compositional Formula (1), the constituent unit represented by [R^{a}SiO_{3/2}] in Compositional Formula (I-2), and the constituent unit represented by [R³SiO_{3/2}] in Compositional Formula (3).

[R^{a}SiO_{3/2}] (I)

Meanwhile, a constituent unit represented by Formula (II) below (which may be referred to as a “T2 unit” in this specification hereinafter) includes the constituent unit represented by [R¹SiO_{2/2}(OR^{c})] in Compositional Formula (1).

[R^{b}SiO_{2/2}(OR^{c})] (II)

R^{a} in Formula (I) above and R^{b} in Formula (II) above represent a group containing a polymerizable functional group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom. R^{c} in Formula (II) above represents an alkyl group having from 1 to 4 carbons or a hydrogen atom.

A more detailed description of the constituent unit represented by the Formula (I) above is represented by the following Formula (I′). Furthermore, the constituent unit represented by Formula (II) above is represented by Formula (II′) below when described in greater detail. Three oxygen atoms bonded to the silicon atom illustrated in the structure represented by Formula (I′) below are each bonded to another silicon atom (a silicon atom not illustrated in Formula (I′)). On the other hand, two oxygen atoms located above and below the silicon atom illustrated in the structure represented by Formula (II′) below are each bonded to another silicon atom (a silicon atom not illustrated in Formula (II′)). That is, both the T3 unit and the T2 unit are silsesquioxane constituent units (so-called T units) formed by hydrolysis and condensation reactions of corresponding hydrolyzable trifunctional silane compounds.

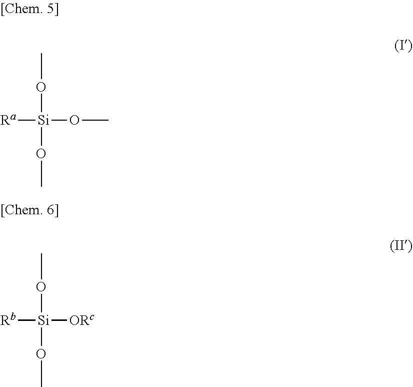

R^{a} in Formula (I′) above, and R^{b} and R^{c} in Formula (II′) above are the same groups as described above. The alkyl group in R^{c} in Formula (II) is typically derived from an alkyl group that forms an alkoxy group [for example, an alkoxy group as X¹ to X³ in Formulas (a) to (c) described later] in the hydrolyzable silane compound used as a raw material for the polyorganosilsesquioxane according to an embodiment of the present disclosure.

The cage-type silsesquioxane represented by Compositional Formula (1) above (T₉) is a so-called incomplete cage-type silsesquioxane, in which T₉ has a structure with nine Si (atoms) at the center, each Si having an organic functional group (R¹) and a silanol group or its ester (OR^{c}) as substituents. The number of groups containing a polymerizable functional group in R¹ in Compositional Formula (1) above is preferably from 3 to 9, more preferably from 5 to 9, even more preferably from 7 to 9, and still more preferably 9 (meaning all groups contain a polymerizable functional group).

The cage-type silsesquioxane represented by Compositional Formula (1) above is a silsesquioxane in which eight constituent units represented by [R¹SiO_{3/2}](T3 units) and one constituent unit represented by [R¹SiO_{2/2}(OR^{c})] (T2 unit) are bonded to each other via siloxane bonds (Si—O—Si) to form a cage structure. The specific structure of the cage-type silsesquioxane represented by Compositional Formula (1) above is not limited as long as the structure satisfies Compositional Formula (1) above, but examples of the estimated structure include a cage-type silsesquioxane represented by Formula (1′) below.

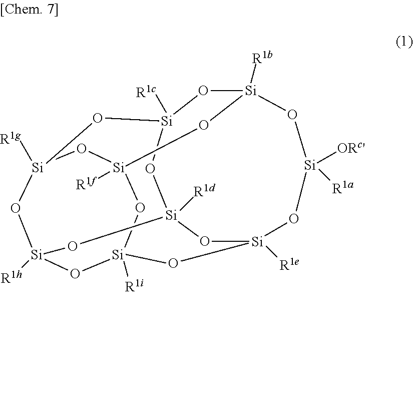

R^{1a} to R¹ⁱ in Formula (1′) each independently has the same definition as R¹ in Compositional Formula (1). R^{c} in Formula (1′) also has the same definition as R^{c} in Compositional Formula (1).

The cage-type silsesquioxane having a constituent unit represented by Compositional Formula (I-2) above (T₁₀) has a structure with ten Si (atoms) at the center, each Si having an organic functional group (R^{a}) as a substituent; T₁₀ does not have a silanol group or its ester.

The cage-type silsesquioxane represented by Compositional Formula (I-2) above is a silsesquioxane in which ten constituent units represented by [R^{a}SiO_{3/2}] (T3 units) are bonded to each other via siloxane bonds (Si—O—Si) to form a cage structure. The specific structure of the cage-type silsesquioxane represented by Compositional Formula (I-2) above is not limited as long as the structure satisfies Compositional Formula (I-2) above, but examples of the estimated structure include a cage-type silsesquioxane represented by the formula below.

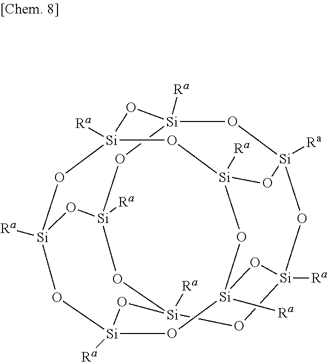

The polyorganosilsesquioxane according to an embodiment of the present disclosure may include another silsesquioxane in addition to T₉ and T₁₀ described above. Examples of another silsesquioxane include an incomplete cage-type silsesquioxane in addition to T₉, a complete cage-type silsesquioxane in addition to T₁₀, a ladder-type silsesquioxane, and a random-type silsesquioxane.

The “cationically polymerizable functional group” in the group containing a polymerizable functional group is not particularly limited as long as it has cationic polymerizability, and examples thereof include an epoxy group, an oxetane group, a vinyl ether group, and a vinyl phenyl group.

The “radically polymerizable functional group” in the group containing a polymerizable functional group is not limited as long as it has radical polymerizability, and examples thereof include a (meth)acryloyloxy group, a (meth)acrylamide group, a vinyl group, and a vinylthio group.

From the viewpoint of surface hardness (for example, 5H or greater) of the cured product, the polymerizable functional group is preferably an epoxy group or a (meth)acryloyloxy group, more preferably an epoxy group.

Moreover, in T₉ described above, a proportion of the group containing a polymerizable functional group to the total of R¹ (the proportion being based on the number of groups containing a polymerizable functional group) is, for example, 30% or greater, preferably 50% or greater, and more preferably 80% or greater. From the viewpoint of curability of a curable composition and the surface hardness of the cured product, the above proportion is preferably of a greater value, and is preferably the above value or greater.

The group containing a polymerizable functional group in R¹ in Compositional Formula (1) above, R^{a} in Compositional Formula (I-2) above, R^{a} in Formula (I) above, and R^{b} in Formula (II) above is not limited, and examples include known or commonly used groups having an oxirane ring. From the viewpoint of curability of the curable composition, as well as surface hardness and heat resistance of the cured product, the group containing a polymerizable functional group in R¹ in Compositional Formula (1) above, R^{a} in Compositional Formula (I-2) above, R^{a} in Formula (I) above, and R^{b} in Formula (II) above is preferably a group represented by Formula (1a) below, a group represented by Formula (1b) below, a group represented by Formula (1c) below, or a group represented by Formula (1d) below, more preferably a group represented by Formula (1a) below or a group represented by Formula (1c) below, and even more preferably a group represented by Formula (1a) below.

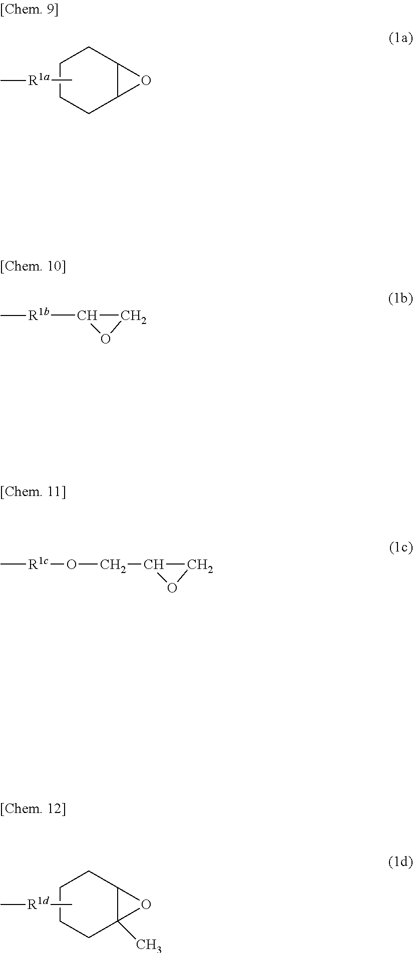

In Formula (1a) above, R^{1a} represents a linear or branched alkylene group. Examples of the linear or branched alkylene group include linear or branched alkylene groups having from 1 to 10 carbons, such as a methylene group, a methyl methylene group, a dimethyl methylene group, an ethylene group, a propylene group, a trimethylene group, a tetramethylene group, a pentamethylene group, a hexamethylene group, and a decamethylene group. Among these, from the viewpoint of surface hardness of the cured product or curability, R^{1a} is preferably a linear alkylene group having from 1 to 4 carbons or a branched alkylene group having 3 or 4 carbons, more preferably an ethylene group, a trimethylene group, or a propylene group, and even more preferably an ethylene group or a trimethylene group.

In Formula (1b) above, R^{1b} represents a linear or branched alkylene group, and examples thereof include the same groups listed as examples of R^{1a}. Among these, from the viewpoint of surface hardness of the cured product or curability, R^{1b} is preferably a linear alkylene group having from 1 to 4 carbons or a branched alkylene group having 3 or 4 carbons, more preferably an ethylene group, a trimethylene group, or a propylene group, and even more preferably an ethylene group or a trimethylene group.

In Formula (1c) above, R^{1c} represents a linear or branched alkylene group, and examples thereof include the same groups listed as examples of R^{1a}. Among these, from the viewpoint of surface hardness of the cured product or curability, R^{1c} is preferably a linear alkylene group having from 1 to 4 carbons or a branched alkylene group having 3 or 4 carbons, more preferably an ethylene group, a trimethylene group, or a propylene group, and even more preferably an ethylene group or a trimethylene group.

In Formula (1d) above, R^{1d} represents a linear or branched alkylene group, and examples thereof include the same groups listed as examples of R^{1a}. Among these, from the viewpoint of surface hardness of the cured product or curability, R^{1d} is preferably a linear alkylene group having from 1 to 4 carbons or a branched alkylene group having 3 or 4 carbons, more preferably an ethylene group, a trimethylene group, or a propylene group, and even more preferably an ethylene group or a trimethylene group.

The group containing a polymerizable functional group is preferably a group represented by Formula (1a) above in which R^{1a} is an ethylene group [of which, a 2-(3′,4′-epoxycyclohexyl)ethyl group is preferred].

Examples of the aryl group of the substituted or unsubstituted aryl group in R¹ in Compositional Formula (1) above, R^{a} in Compositional Formula (I-2) above, R^{a} in Formula (I) above, and R^{b} in Formula (II) above include a phenyl group, a tolyl group, and a naphthyl group.

Examples of the aralkyl group of the substituted or unsubstituted aralkyl group in R¹ in Compositional Formula (1) above, R^{a} in Compositional Formula (I-2) above, R^{a} in Formula (I) above, and R^{b} in Formula (II) above include a benzyl group and a phenethyl group.

Examples of the cycloalkyl group of the substituted or unsubstituted cycloalkyl group in R¹ in Compositional Formula (1) above, R^{a} in Compositional Formula (I-2) above, R^{a} in Formula (I) above, and R^{b} in Formula (II) above include a cyclobutyl group, a cyclopentyl group, and a cyclohexyl group.

Examples of the alkyl group of the substituted or unsubstituted alkyl group in R¹ in Compositional Formula (1) above, R^{a} in Compositional Formula (I-2) above, R^{a} in Formula (I) above, and R^{b} in Formula (II) above include linear or branched alkyl groups, such as a methyl group, an ethyl group, a propyl group, an n-butyl group, an isopropyl group, an isobutyl group, an s-butyl group, a t-butyl group, and an isopentyl group.

Examples of the alkenyl group of the substituted or unsubstituted alkenyl group in R¹ in Compositional Formula (1) above, R^{a} in Compositional Formula (I-2) above, R^{a} in Formula (I) above, and R^{b} in Formula (II) above include linear or branched alkenyl groups, such as a vinyl group, an allyl group, and an isopropenyl group.

Examples of the alkyl group having from 1 to 4 carbons in R^{c} in Compositional Formula (1) above and Formula (II) above include linear or branched alkyl groups having from 1 to 4 carbons, such as a methyl group, an ethyl group, a propyl group, an isopropyl group, a butyl group, and an isobutyl group.

The above T₉, T₈, T₁₀, and other silsesquioxanes, which the polyorganosilsesquioxane according to an embodiment of the present disclosure may include, all contain a silsesquioxane constituent unit generally represented by [RSiO_{3/2}] (so-called T unit). Note that, R in the formula above represents a monovalent organic group, and the same applies hereinafter. The silsesquioxane constituent unit can be formed by a hydrolysis and condensation reaction of a corresponding hydrolyzable trifunctional silane compound (specifically, a compound represented by Formulas (a) to (c) described later, for example).

In the polyorganosilsesquioxane according to an embodiment of the present disclosure, a molar ratio of the constituent units represented by Formula (I) above (T3 units) to the constituent units represented by Formula (II) above (T2 units) [constituent units represented by Formula (I)/constituent units represented by Formula (II); T3 units/T2 units] is not limited, but is, for example, from 1 to 500.

Note that T₉ is composed of eight T3 units and one T2 unit, while T₁₀ is composed of ten T3 units. The T3 unit and T2 unit in the polyorganosilsesquioxane according to an embodiment of the present disclosure respectively include the T3 unit and the T2 unit constituting T₉ or T₁₀, and further respectively include a T3 unit and a T2 unit constituting all other silsesquioxanes in addition to those described above.

A lower limit of the above-mentioned ratio [T3 units/T2 units] is 1 as described above, preferably 2, more preferably 3, more preferably 4, more preferably 5, more preferably 6, more preferably 7, more preferably 8, even more preferably 9, and still more preferably 10. Setting the above-mentioned ratio [T3 units/T2 units] to 1 or greater significantly improves the surface hardness and/or adhesiveness of the cured product or a hard coat layer. Meanwhile, an upper limit of the above-mentioned ratio [T3 units/T2 units] is 500 as described above, preferably 100, more preferably 50, more preferably 40, more preferably 30, more preferably 25, more preferably 20, more preferably 18, and even more preferably 16. By setting the abovementioned [T3 forms/T2 forms] ratio to 500 or less, miscibility with other components in the curable composition is improved, and viscosity is suppressed, and therefore handling is simplified, and coating as a hard coat layer is facilitated.

In addition to the silsesquioxane constituent unit [RSiO_{3/2}] (T unit), the polyorganosilsesquioxane according to an embodiment of the present disclosure may contain at least one siloxane constituent unit selected from the group consisting of a constituent unit represented by [(R)₃SiO_{1/2}] (so-called M unit), a constituent unit represented by [(R)₂SIO_{2/2}] (so-called D unit), and a constituent unit represented by [SiO_{4/2}] (so-called Q unit).

The above-mentioned ratio [T3 units/T2 units] in the polyorganosilsesquioxane according to an embodiment of the present disclosure can be determined, for example, by ²⁹Si-NMR spectroscopic analysis. In the ²⁹Si-NMR spectrum, the silicon atoms in the constituent units represented by Formula (I) above (T3 units) and the silicon atoms in the constituent units represented by Formula (II) above (T2 units) exhibit signals (peaks) at different positions (chemical shifts), and thus the above-mentioned ratio [T3 units/T2 units] can be determined by calculating the integration ratio of each of these peaks. In the polyorganosilsesquioxane according to an embodiment of the present disclosure, the signal of the silicon atoms in the structures represented by Formula (I) above (T3 units) in which R^{a} is a 2-(3′,4′-epoxycyclohexyl)ethyl group appears at from −64 to −70 ppm, while the signal of the silicon atoms in the structures represented by Formula (II) above (T2 units) in which R^{b} is a 2-(3′,4′-epoxycyclohexyl)ethyl group appears at from −54 to −60 ppm. Thus, in this case, the above [T3 form/T2 form] ratio can be determined by calculating the integration ratio of the signal at −64 to −70 ppm (T3 form) and the signal at −54 to −60 ppm (T2 form).

The ²⁹Si-NMR spectrum of the polyorganosilsesquioxane according to an embodiment of the present disclosure can be measured, for example, by using the following instrument under the following conditions.

Measuring apparatus: Trade name “Brucker AVANCE (600 MHz)” (available from Brucker)

Solvent: Deuterochloroform

Number of scans: 8000

Measurement temperature: 25° C.

Sample: Polyorganosilsesquioxane/Chromium(III)

### Acetylacetonate/Deuterated Chloroform (1% Tetramethylsilane)=2.0:0.10:4.0 (Weight Ratio)

When the above-mentioned ratio [T3 units/T2 units] of the polyorganosilsesquioxane according to an embodiment of the present disclosure is 1 or greater, the amount of T2 units present in the polyorganosilsesquioxane according to an embodiment of the present disclosure is the same or relatively smaller than the amount of T3 units present in the polyorganosilsesquioxane, and the hydrolysis and condensation reaction of silanol have advanced considerably.

A number average molecular weight (Mn) of the polyorganosilsesquioxane according to an embodiment of the present disclosure, determined by gel permeation chromatography and calibrated with standard polystyrene, is from 1000 to 50000, preferably from 1100 to 40000, and more preferably from 1200 to 30000, for example. Setting the number average molecular weight to the lower limit or greater further improves the heat resistance, scratch resistance, and/or adhesiveness of the cured product. Meanwhile, setting the number average molecular weight to the upper limit or smaller improves the compatibility with other components in the curable composition and further improves the heat resistance of the resulting cured product.

A polydispersity index (Mw/Mn) of the polyorganosilsesquioxane according to an embodiment of the present disclosure, determined by gel permeation chromatography and calibrated with standard polystyrene, is from 1.0 to 4.0, preferably from 1.1 to 3.0, and more preferably from 1.2 to 2.5, for example. When the molecular weight dispersity is set to 4.0 or less, the surface hardness and adhesion of the resulting cured product are further increased. On the other hand, the polyorganosilsesquioxane with a molecular weight dispersity of 1.0 or greater tends to easily become liquid and improve the handleability.

Note that, the number average molecular weight and the polydispersity index of the polyorganosilsesquioxane according to an embodiment of the present disclosure can be measured by the following instruments under the following conditions.

Measurement instrument: “LC-20AD” (trade name, available from Shimadzu Corporation)

Column: Shodex KF-801×2, KF-802, and KF-803 (available from Showa Denko K.K.)

Measurement temperature: 40° C.

Eluent: THF, sample concentration of 0.1 to 0.2 wt. %

Flow rate: 1 mL/min

Detector: RI detector (available from Shoko Science Co., Ltd.)

Molecular weight: calibrated with standard polystyrene

A 5% weight loss temperature (T_{d5}) of the polyorganosilsesquioxane according to an embodiment of the present disclosure in an air atmosphere is not limited, but is preferably 330° C. or higher (for example, from 330 to 450° C.), more preferably 340° C. or higher, and even more preferably 350° C. or higher. The polyorganosilsesquioxane with a 5% weight loss temperature of 330° C. or higher tends to further improve the heat resistance of the cured product. When the polyorganosilsesquioxane according to an embodiment of the present disclosure has an above-mentioned ratio [T3 units/T2 units] from 1 to 500, a number average molecular weight from 1000 to 50000, and a polydispersity index from 1.0 to 4.0, the 5% weight loss temperature the polyorganosilsesquioxane according to an embodiment of the present disclosure is 330° C. or higher. Here, the 5% weight loss temperature is a temperature at which the weight decreases by 5% compared to a weight prior to heating when heating is performed at a constant temperature increase rate, and is an indicator of heat resistance. The 5% weight loss temperature can be measured by thermogravimetric analysis (TGA) under conditions of a temperature increase rate of 5° C./min in an air atmosphere.

The method for producing the polyorganosilsesquioxane according to an embodiment of the present discloser is not limited, and the polyorganosilsesquioxane can be produced by a known or commonly used polysiloxane production method. Examples thereof include a method of subjecting one or more types of hydrolyzable silane compounds to hydrolysis and condensation. It should be noted that, regarding the hydrolyzable silane compound above, a compound represented by Formula (a) below, which is a hydrolyzable trifunctional silane compound for forming the constituent unit of T₉ described above, needs to be used as an essential hydrolyzable silane compound.

More specifically, for example, the polyorganosilsesquioxane according to an embodiment of the present disclosure can be produced by a method of hydrolysis and condensation of a compound represented by Formula (a) below, which is a hydrolyzable silane compound for forming the silsesquioxane constituent unit (T unit) in the polyorganosilsesquioxane according to an embodiment of the present disclosure, and additionally as necessary, hydrolysis and condensation of a compound represented by Formula (b) below and a compound represented by Formula (c) below.

R^{A}Si(X¹)₃(a) [Chem. 13]

R^{B}Si(X²)₃(b) [Chem. 14]

HSi(X³)₃(c) [Chem. 15]

The compound represented by Formula (a) above is an essential compound for formation of the constituent unit of T₉ in the polyorganosilsesquioxane according to an embodiment of the present disclosure, that is, R^{A} in Formula (a) is a group containing a polymerizable functional group. R^{A} in Formula (a) is preferably a group represented by Formula (1a) above, a group represented by Formula (1b) above, a group represented by Formula (1c) above, or a group represented by Formula (1d) above, more preferably a group represented by Formula (1a) above or a group represented by Formula (1c) above, even more preferably a group represented by Formula (1a) above, and still more preferably a group represented by Formula (1a) above in which R^{1a} is an ethylene group (in particular, a 2-(3′,4′-epoxycyclohexyl)ethyl group).

X¹ in Formula (a) above represents an alkoxy group or a halogen atom. Examples of the alkoxy group in X¹ include alkoxy groups having from 1 to 4 carbons, such as a methoxy group, an ethoxy group, a propoxy group, an isopropyloxy group, a butoxy group, and an isobutyloxy group. Examples of the halogen atom in X¹ include a fluorine atom, a chlorine atom, a bromine atom, and an iodine atom. Among these, X¹ is preferably an alkoxy group, more preferably a methoxy group or an ethoxy group. Note that, each of the three X¹s may be the same or different.

The compound represented by Formula (b) above is a compound that forms a constituent unit of T₉ in the polyorganosilsesquioxane according to an embodiment of the present disclosure. R^{B} in Formula (b) represents a substituted or unsubstituted aryl group, a substituted or unsubstituted aralkyl group, a substituted or unsubstituted cycloalkyl group, a substituted or unsubstituted alkyl group, or a substituted or unsubstituted alkenyl group. R² in Formula (b) is preferably a substituted or unsubstituted aryl group, a substituted or unsubstituted alkyl group, or a substituted or unsubstituted alkenyl group, more preferably a substituted or unsubstituted aryl group, and even more preferably a phenyl group.

X² in Formula (b) above represents an alkoxy group or a halogen atom. Specific examples of X² include those listed as examples of X¹. Among these, X² is preferably an alkoxy group, and more preferably a methoxy group or an ethoxy group. Note that, each of the three X²s may be the same or different.

The compound represented by Formula (c) above is a compound that forms a constituent unit of T₉ in the polyorganosilsesquioxane according to an embodiment of the present disclosure, the constituent unit being represented by [HSiO_{3/2}]. X³ in Formula (c) above represents an alkoxy group or a halogen atom. Specific examples of X³ include those listed as examples of X¹. Among these, X³ is preferably an alkoxy group, more preferably a methoxy group or an ethoxy group. Note that, each of the three X³s may be the same or different.

The compounds represented by Formulas (a) to (c) above are, in addition to the raw material compounds for the constituent unit of T₉, also raw material compounds for the formation of a constituent unit of another silsesquioxane (for example, an incomplete cage-type silsesquioxane in addition to T₉, a complete cage-type silsesquioxane such as T₁₀, a ladder-type silsesquioxane, and a random-type silsesquioxane) that may be included in the polyorganosilsesquioxane according to an embodiment of the present disclosure.

A hydrolyzable silane compound other than the compounds represented by Formulae (a) to (c) above may be used in combination as the hydrolyzable silane compound. Examples thereof include hydrolyzable trifunctional silane compounds other than the compounds represented by Formulae (a) to (c) above, hydrolyzable monofunctional silane compounds forming an M unit, hydrolyzable bifunctional silane compounds forming a D unit, and hydrolyzable tetrafunctional silane compounds forming a Q unit.

An amount of the hydrolyzable silane compound used and the composition of the hydrolyzable silane compound can be appropriately adjusted according to the desired structure of the polyorganosilsesquioxane according to an embodiment of the present disclosure. For example, an amount of the compound represented by Formula (a) above to be used relative to a total amount (100 mol %) of the hydrolyzable silane compounds to be used is not limited, but is preferably from 30 to 100 mol %, preferably from 55 to 100 mol %, more preferably from 65 to 100 mol %, and even more preferably from 80 to 99 mol %.

In addition, the usage amount of the compound represented by Formula (b) above is not particularly limited but is preferably from 0 to 70 mol %, more preferably from 0 to 60 mol %, even more preferably from 0 to 40 mol %, and particularly preferably from 1 to 15 mol %, relative to a total amount (100 mol %) of the hydrolyzable silane compounds used.

Furthermore, the ratio (ratio of a total amount) of the compound represented by Formula (a) and the compound represented by Formula (b) relative to a total amount (100 mol %) of the hydrolyzable silane compounds used is preferably from 60 to 100 mol %, more preferably from 70 to 100 mol %, and even more preferably from 80 to 100 mol %.

In addition, in a case where two or more types of the hydrolyzable silane compounds are used in combination, the hydrolysis and condensation reaction of these hydrolyzable silane compounds can be performed simultaneously or sequentially. The order of the reactions when performed sequentially is not particularly limited.

For the reaction conditions for performing the hydrolysis and condensation reaction of the hydrolyzable silane compound, it is important that reaction conditions are selected such that the peak area % of T₉ in the polyorganosilsesquioxane according to an embodiment of the present disclosure reaches 5% or greater.

The hydrolysis and condensation reaction can be performed in the presence or absence of a solvent. Among these, the hydrolysis and condensation reaction are preferably performed in the presence of a solvent. Examples of the solvent include aromatic hydrocarbons, such as benzene, toluene, xylene, and ethylbenzene; ethers, such as diethyl ether, dimethoxyethane, tetrahydrofuran, and dioxane; ketones, such as acetone, methyl ethyl ketone, and methyl isobutyl ketone; esters, such as methyl acetate, ethyl acetate, isopropyl acetate, and butyl acetate; amides, such as N,N-dimethylformamide and N,N-dimethylacetamide; nitriles, such as acetonitrile, propionitrile, and benzonitrile; and alcohols, such as methanol, ethanol, isopropyl alcohol, and butanol. From the viewpoint of the ease of controlling the peak area % of T₉ to 5% or greater, the solvent is preferably a ketone, an ether, an amide, or an alcohol, more preferably methyl isobutyl ketone, acetone, tetrahydrofuran, N,N-dimethylacetamide, or isopropyl alcohol, and even more preferably methyl isobutyl ketone or tetrahydrofuran. In addition, one type of the solvent can be used alone, or two or more types thereof can be used in combination.

An amount of the solvent used in the hydrolysis and condensation reaction is not limited and can be appropriately adjusted in a range of 0 to 2000 parts by weight relative to 100 parts by weight of a total amount of the hydrolyzable silane compound, depending on the desired reaction time or the type of solvent used, etc.; however, from the viewpoint of the ease of controlling the peak area % of T₉ to 5% or greater, the amount of the solvent used is preferably from 200 to 1500 parts by weight, more preferably from 300 to 1000 parts by weight.

The hydrolysis and condensation reaction is preferably carried out in the presence of a catalyst and water. The catalyst may be an acid catalyst or an alkali catalyst, but an alkali catalyst is preferable in order to suppress degradation of the polymerizable functional group, such as an epoxy group. Examples of the acid catalyst include mineral acids, such as hydrochloric acid, sulfuric acid, nitric acid, phosphoric acid, and boric acid; phosphate esters; carboxylic acids, such as acetic acid, formic acid, and trifluoroacetic acid; sulfonic acids, such as methanesulfonic acid, trifluoromethanesulfonic acid, and p-toluenesulfonic acid; solid acids, such as activated clay; and Lewis acids, such as iron chloride. Examples of the alkali catalyst include alkali metal hydroxides, such as lithium hydroxide, sodium hydroxide, potassium hydroxide, and cesium hydroxide; alkaline earth metal hydroxides, such as magnesium hydroxide, calcium hydroxide, and barium hydroxide; alkali metal carbonates, such as lithium carbonate, sodium carbonate, potassium carbonate, and cesium carbonate; alkaline earth metal carbonates, such as magnesium carbonate; alkali metal hydrogencarbonates, such as lithium hydrogencarbonate, sodium hydrogencarbonate, potassium hydrogencarbonate, and cesium hydrogencarbonate; alkali metal organic acid salts (for example, acetates), such as lithium acetate, sodium acetate, potassium acetate, and cesium acetate; alkaline earth metal organic acid salts (for example, acetates), such as magnesium acetate; alkali metal alkoxides, such as lithium methoxide, sodium methoxide, sodium ethoxide, sodium isopropoxide, potassium ethoxide, and potassium t-butoxide; alkali metal phenoxides, such as sodium phenoxide; amines (tertiary amines), such as triethylamine, N-methylpiperidine, 1,8-diazabicyclo[5.4.0]undec-7-ene, and 1,5-diazabicyclo[4.3.0]non-5-ene; and nitrogen-containing heterocyclic aromatic compounds, such as pyridine, 2,2′-bipyridyl, and 1,10-phenanthroline. From the viewpoint of the ease of controlling the peak area % of T₉ to 5% or greater, the alkali catalyst is preferably an alkali metal carbonate, an alkali metal hydroxide, or an amine, more preferably an alkali metal carbonate, and even more preferably potassium carbonate. Here, one type of the catalyst can be used alone, or two or more types thereof can be used in combination. In addition, the catalyst can be used in a state of being dissolved or dispersed in water, a solvent, or the like.

An amount of the catalyst used in the hydrolysis and condensation reaction is not limited and can be appropriately adjusted in a range of 0.000001 to 0.200 mol relative to a total amount of 1 mol of the hydrolyzable silane compound; however, from the viewpoint of the ease of controlling the peak area % of T₉ to 5% or greater, the amount of the catalyst used is preferably from 0.00001 to 0.10 mol, more preferably from 0.0001 to 0.05 mol.

An amount of water used during the hydrolysis and condensation reaction is not limited and can be appropriately adjusted in a range from 0.5 to 20 mol relative to a total amount of 1 mol of the hydrolyzable silane compound; however, from the viewpoint of the ease of controlling the peak area % of T₉ to 5% or greater, the amount of water used is preferably from 1 to 15 mol, more preferably from 2 to 10 mol.

A method for adding the water in the hydrolysis and condensation reaction is not limited, and the total amount of water used (total amount used) may be added all at once or may be added sequentially. When the water is added sequentially, it may be added continuously or intermittently.

A reaction temperature of the hydrolysis and condensation reaction is not limited; however, from the viewpoint of the ease of controlling the peak area % of T9 to 5% or greater, the reaction temperature is preferably from 20 to 100° C., more preferably from 45 to 80° C., even more preferably from 30 to 80° C., and still more preferably from 40 to 70° C. A reaction time of the hydrolysis and condensation reaction, although not limited, is preferably from 0.1 to 10 hours, more preferably from 1.5 to 8 hours. Furthermore, the hydrolysis and condensation reaction can be performed under normal pressure, increased pressure, or reduced pressure. Note that, an atmosphere when performing the hydrolysis and condensation reaction is not limited, and for example, the reaction may be performed either in an inert gas atmosphere, such as a nitrogen atmosphere or an argon atmosphere, or in the presence of oxygen, such as in the air. However, the hydrolysis and condensation reaction is preferably performed in an inert gas atmosphere.

A polyorganosilsesquioxane can be obtained by the hydrolysis and condensation reaction. After completion of the hydrolysis and condensation reaction, the catalyst is preferably neutralized to prevent degradation of the polymerizable functional group, such as ring-opening of the epoxy group. The polyorganosilsesquioxane obtained may be separated and purified by a separation means such as washing with water, washing with acid, washing with alkali, filtration, concentration, distillation, extraction, crystallization, recrystallization, or column chromatography, or a separation means that is a combination thereof.

The polyorganosilsesquioxane according to an embodiment of the present disclosure contains a large amount of the cage-type silsesquioxane (T₉) represented by Compositional Formula (1) above; as such, compared to a polyorganosilsesquioxane known in the art, the polyorganosilsesquioxane according to an embodiment of the present disclosure tends to have a higher (number average) molecular weight and a flexible structure. Furthermore, it is believed that when the proportion of T₉ in the polyorganosilsesquioxane according to an embodiment of the present disclosure is large, a Si—OR^{c} contained in T₉ is further condensed with another Si—OR^{c} contained in another T₉ or the like, for example, or a Si—OR contained in T₉ becomes a cross-linking point that reacts with a polymerizable functional group contained in another T₉, T₈, T₁₀, or the like, increasing the cross-linking density. As such, the cured product of the curable composition containing the polyorganosilsesquioxane according to an embodiment of the present disclosure has a high surface hardness and heat resistance, and is excellent in flexibility and processability. However, these mechanisms are only inferences, and the present disclosure should not be construed as limited to these mechanisms.

### Curable Composition

The curable composition according to an embodiment of the present disclosure is a curable composition (curable resin composition) containing the above-described polyorganosilsesquioxane according to an embodiment of the present disclosure as an essential component. As described below, the curable composition according to an embodiment of the present disclosure may further contain an additional component, such as a curing catalyst (preferably a photocationic polymerization initiator), a surface conditioner, or a surface modifier. Note that in the curable composition according to an embodiment of the present disclosure, one type of the polyorganosilsesquioxane according to an embodiment of the present disclosure can be used alone, or two or more types thereof can be used in combination.

A content (blended amount) of the polyorganosilsesquioxane according to an embodiment of the present disclosure in the curable composition according to an embodiment of the present disclosure relative to a total amount (100 wt. %) of the curable composition excluding solvent is not limited, but is preferably from 70 wt. % to less than 100 wt. %, more preferably from 80 to 99.8 wt. %, and even more preferably from 90 to 99.5 wt. %. Setting the content of the polyorganosilsesquioxane according to an embodiment of the present disclosure to 70 wt. % or greater tends to further improve the hardness of the cured product. Meanwhile, setting the content of the polyorganosilsesquioxane according to an embodiment of the present disclosure to less than 100 wt. % allows the inclusion of a curing catalyst, and thereby curing of the curable composition tends to advance more efficiently.

A content of the polyorganosilsesquioxane according to an embodiment of the present disclosure relative to a total amount (100 wt. %) of a cationically curable compound contained in the curable composition according to an embodiment of the present disclosure is preferably from 70 to 100 wt. %, more preferably from 75 to 98 wt. %, and even more preferably from 80 to 95 wt. %. Setting the content of the polyorganosilsesquioxane according to an embodiment of the present disclosure to 70 wt. % or greater tends to further improve the surface hardness and adhesiveness of the cured product.

The curable composition according to an embodiment of the present disclosure preferably further contains a curing catalyst. Among the curing catalysts, from the viewpoint of shortening a curing time until the curable composition according to an embodiment of the present disclosure becomes tack free, the curable composition preferably contains a photopolymerization initiator or a thermal polymerization initiator as a curing catalyst, more preferably a cationic polymerization initiator. In the curable composition according to an embodiment of the present disclosure, one type of the curing catalyst can be used alone, or two or more types thereof can be used in combination.

The cationic polymerization initiator is a compound capable of initiating and/or accelerating a cationic polymerization reaction of a cationically curable compound such as the polyorganosilsesquioxane according to an embodiment of the present disclosure. The cationic polymerization initiator is not particularly limited, and examples thereof include photocationic polymerization initiators (photo acid generating agents) and thermal cationic polymerization initiators (thermal acid generating agents).

Known or commonly used photocationic polymerization initiators can be used as the photocationic polymerization initiator, and examples thereof include a sulfonium salt (a salt of a sulfonium ion and an anion), an iodonium salt (a salt of an iodonium ion and an anion), a selenium salt (a salt of a selenium ion and an anion), an ammonium salt (a salt of an ammonium ion and an anion), a phosphonium salt (a salt of a phosphonium ion and an anion), and a salt of a transition metal complex ion and an anion. One of these can be used alone, or two or more in combination.

Examples of the sulfonium salt include a triarylsulfonium salt, such as [4-(4-biphenylylthio)phenyl]-4-biphenylylphenyl sulfonium tris(pentafluoroethyl) trifluorophosphate, a triphenylsulfonium salt, a tri-p-tolylsulfonium salt, a tri-o-tolylsulfonium salt, a tris(4-methoxyphenyl)sulfonium salt, a 1-naphthyldiphenylsulfonium salt, a 2-naphthyldiphenylsulfonium salt, a tris(4-fluorophenyl)sulfonium salt, a tri-1-naphthylsulfonium salt, a tri-2-naphthylsulfonium salt, a tris(4-hydroxyphenyl)sulfonium salt, a diphenyl[4-(phenylthio)phenyl]sulfonium salt, and a 4-(p-tolylthio)phenyl di-(p-phenyl) sulfonium salt; a diarylsulfonium salt, such as a diphenylphenacylsulfonium salt, a diphenyl 4-nitrophenacylsulfonium salt, a diphenylbenzylsulfonium salt, and a diphenylmethylsulfonium salt; a monoarylsulfonium salt, such as a phenylmethylbenzylsulfonium salt, a 4-hydroxyphenylmethylbenzylsulfonium salt, and a 4-methoxyphenylmethylbenzylsulfonium salt; and a trialkylsulfonium salt, such as a dimethylphenacylsulfonium salt, a phenacyltetrahydrothiophenium salt, and a dimethylbenzylsulfonium salt.

As the diphenyl [4-(phenylthio)phenyl]sulfonium salt, for example, diphenyl[4-(phenylthio)phenyl]sulfonium hexafluoroantimonate and (diphenyl[4-(phenylthio)phenyl]sulfonium hexafluorophosphate can be used.

Examples of the iodonium salt include “UV9380C” (trade name, a bis(4-dodecylphenyl)iodonium=hexafluoroantimonate 45% alkyl glycidyl ether solution, available from Momentive Performance Materials Japan LLC), “RHODORSIL PHOTOINITIATOR 2074” (trade name, tetrakis(pentafluorophenyl)borate=[(1-methylethyl)phenyl](methylphenyl)iodonium, available from Rhodia Japan Ltd.), “WPI-124” (trade name, available from Wako Pure Chemical Industries, Ltd.), a diphenyliodonium salt, a di-p-tolyliodonium salt, a bis(4-dodecylphenyl)iodonium salt, and a bis(4-methoxyphenyl)iodonium salt.

Examples of the selenium salt include a triarylselenium salt, such as a triphenylselenium salt, a tri-p-tolylselenium salt, a tri-o-tolylselenium salt, a tris(4-methoxyphenyl)selenium salt, and a 1-naphthyldiphenylselenium salt; a diarylselenium salt, such as a diphenylphenacylselenium salt, a diphenylbenzylselenium salt, and a diphenylmethylselenium salt; a monoarylselenium salt, such as a phenylmethylbenzylselenium salt; and a trialkylselenium salt, such as a dimethylphenacylselenium salt.

Examples of the ammonium salt include a tetraalkyl ammonium salt, such as a tetramethyl ammonium salt, an ethyltrimethyl ammonium salt, a diethyldimethyl ammonium salt, a triethylmethyl ammonium salt, a tetraethyl ammonium salt, a trimethyl-n-propyl ammonium salt, and a trimethyl-n-butyl ammonium salt; a pyrrolidium salt, such as an N,N-dimethylpyrrolidium salt and an N-ethyl-N-methylpyrrolidium salt; an imidazolinium salt, such as an N,N′-dimethylimidazolinium salt and an N,N′-diethylimidazolinium salt; a tetrahydropyrimidium salt, such as an N,N′-dimethyltetrahydropyrimidium salt and an N,N′-diethyltetrahydropyrimidium salt; a morpholinium salt, such as an N,N-dimethylmorpholinium salt and an N,N-diethylmorpholinium salt; a piperidinium salt, such as an N,N-dimethylpiperidinium salt and an N,N-diethylpiperidinium salt; a pyridinium salt, such as an N-methylpyridinium salt and an N-ethylpyridinium salt; an imidazolium salt, such as an N,N′-dimethylimidazolium salt; a quinolium salt, such as an N-methylquinolium salt; an isoquinolium salt, such as an N-methylisoquinolium salt; a thiazonium salt, such as a benzylbenzothiazonium salt; and an acrydium salt, such as a benzylacrydium salt.

Examples of the phosphonium salt include a tetra-arylphosphonium salt, such as a tetra-phenylphosphonium salt, a tetra-p-tolylphosphonium salt, and a tetrakis(2-methoxyphenyl)phosphonium salt; a triarylphosphonium salt, such as a triphenylbenzylphosphonium salt; and a tetra-alkylphosphonium salt, such as a triethylbenzylphosphonium salt, a tributylbenzylphosphonium salt, a tetra-ethylphosphonium salt, a tetra-butylphosphonium salt, and a triethylphenacylphosphonium salt.

Examples of the salt of the transition metal complex ion include a salt of a chromium complex cation, such as (η5-cyclopentadienyl)(η6-toluene)Cr⁺ and (η5-cyclopentadienyl)(η6-xylene)Cr⁺; and a salt of an iron complex cation, such as (η5-cyclopentadienyl)(η6-toluene)Fe⁺ and (η5-cyclopentadienyl)(η6-xylene)Fe⁺.

Examples of the anion constituting the salt described above include SbF₆⁻, PF₆⁻, BF₄⁻, (CF₃CF₂)₃PF₃⁻, (CF₃CF₂CF₂)₃PF₃⁻, (C₆F₅)₄B⁻, (C₆F₅)₄Ga⁻, a sulfonate anion (such as a trifluoromethanesulfonate anion, a pentafluoroethanesulfonate anion, a nonafluorobutanesulfonate anion, a methanesulfonate anion, a benzenesulfonate anion, and a p-toluenesulfonate anion), (CF₃SO₂)₃C⁻, (CF₃SO₂)₂N⁻, a perhalogenate ion, a halogenated sulfonate ion, a sulfate ion, a carbonate ion, an aluminate ion, a hexafluorobismuthate ion, a carboxylate ion, an arylborate ion, a thiocyanate ion, and a nitrate ion.

Examples of the thermal cationic polymerization initiator include arylsulfonium salts, aryliodonium salts, allene-ion complexes, quaternary ammonium salts, aluminum chelates, and boron trifluoride amine complexes.

Examples of the arylsulfonium salt include hexafluoroantimonate salts and the like. In the curable composition according to an embodiment of the present disclosure, commercially available products, such as “SP-66” and “SP-77” (product names, available from ADEKA Corporation), “SAN-AID SI-60L”, “SAN-AID SI-80 L”, “SAN-AID SI-100L” and “SAN-AID SI-150 L” (product names, available from Sanshin Chemical Industry Co., Ltd.), can be used. Examples of the aluminum chelate include ethylacetoacetate aluminum diisopropylate and aluminum tris(ethylacetoacetate). Examples of the boron trifluoride amine complex include a boron trifluoride monoethyl amine complex, a boron trifluoride imidazole complex, and a boron trifluoride piperidine complex.

A content (blended amount) of the curing catalyst in the curable composition according to an embodiment of the present disclosure with respect to 100 parts by weight of a total amount of the polyorganosilsesquioxane according to an embodiment of the present disclosure and an additional cationically curable compound to be described later is not limited, but is preferably from 0.01 to 3.0 parts by weight, more preferably from 0.05 to 3.0 parts by weight, even more preferably from 0.1 to 1.0 parts by weight (for example, from 0.3 to 1.0 part by weight). Setting the content amount of the curing catalyst to 0.01 parts by weight or greater can allow the curing reaction to efficiently and sufficiently proceed, and the surface hardness and adhesion of the resulting cured product tend to improve. On the other hand, setting the content amount of the curing catalyst to 3.0 parts by weight or less tends to further improve the storage properties of the curable composition and to prevent coloration of the resulting cured product.

The curable composition according to an embodiment of the present disclosure may further include a cationically curable compound in addition to the polyorganosilsesquioxane according to an embodiment of the present disclosure (which may be referred to as an “additional cationically curable compound”). The additional cationically curable compound can be a known or commonly used cationically curable compound. Examples thereof include an epoxy compound other than the polyorganosilsesquioxane according to an embodiment of the present disclosure, an oxetane compound, and a vinyl ether compound. Note that, in the curable composition according to an embodiment of the present disclosure, one type of the additional cationically curable compound can be used alone, or two or more types thereof can be used in combination.

For the epoxy compound described above, a known or commonly used compound having one or more epoxy groups (oxirane rings) per molecule can be used. The epoxy compound is not particularly limited, and the examples thereof include alicyclic epoxy compounds (alicyclic epoxy resins), aromatic epoxy compounds (aromatic epoxy resins), and aliphatic epoxy compounds (aliphatic epoxy resins).

For the alicyclic epoxy compound, examples include known or commonly used compounds that have one or more alicyclic rings and one or more epoxy groups in the molecule. Such an alicyclic epoxy compound is not limited, and examples thereof include a compound including an epoxy group composed of two adjacent carbon atoms that are a part of an alicyclic ring and an oxygen atom in the molecule (referred to as an “alicyclic epoxy group”), a compound in which an epoxy group is directly bonded to an alicyclic ring via a single bond, and a compound having an alicyclic ring and a glycidyl ether group in the molecule (a glycidyl ether type epoxy compound).

Examples of the compound having an alicyclic epoxy group include compounds represented by Formula (i) below.

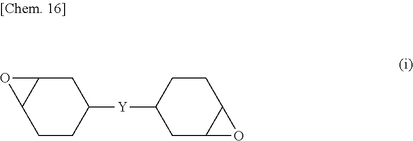

In Formula (i) above, Y represents a single bond or a linking group (a divalent group having one or more atoms). Examples of the linking group include a divalent hydrocarbon group, an epoxidized alkenylene group in which some or all of carbon-carbon double bonds are epoxidized, a carbonyl group, an ether bond, an ester bond, a carbonate group, an amide group, and a linked group in which a plurality of the above groups are linked.

Examples of the divalent hydrocarbon group include linear or branched alkylene groups having from 1 to 18 carbons and divalent alicyclic hydrocarbon groups. Examples of the linear or branched alkylene group having from 1 to 18 carbons include a methylene group, a methyl methylene group, a dimethyl methylene group, an ethylene group, a propylene group, and a trimethylene group. Examples of the divalent alicyclic hydrocarbon group include a divalent cycloalkylene group (including a cycloalkylidene group), such as a 1,2-cyclopentylene group, a 1,3-cyclopentylene group, a cyclopentylidene group, a 1,2-cyclohexylene group, a 1,3-cyclohexylene group, a 1,4-cyclohexylene group, and a cyclohexylidene group.

Examples of the alkenylene group in the alkenylene group in which some or all of the carbon-carbon double bonds are epoxidized (which may be referred to as an “epoxidized alkenylene group”) include linear or branched alkenylene groups having from 2 to 8 carbons, such as a vinylene group, a propenylene group, a 1-butenylene group, a 2-butenylene group, a butadienylene group, a pentenylene group, a hexenylene group, a heptenylene group, and an octenylene group. The epoxidized alkenylene group is preferably an epoxidized alkenylene group in which all of the carbon-carbon double bonds are epoxidized, more preferably an epoxidized alkenylene group having from 2 to 4 carbons in which all of the carbon-carbon double bonds are epoxidized.

Representative examples of the alicyclic epoxy compound represented by Formula (i) above include (3,4,3′,4′-diepoxy)bicyclohexyl and compounds represented by Formulae (i-1) to (i-10) below. In Formulae (i-5) and (i-7) below, 1 and m each represent an integer from 1 to 30. R^{c} in Formula (i-5) below is an alkylene group having from 1 to 8 carbon atoms, and, among these, a linear or branched alkylene group having from 1 to 3 carbon atoms, such as a methylene group, an ethylene group, a propylene group, or an isopropylene group, is preferable. In Formulae (i-9) and (i-10) below, n1 to n6 each represent an integer from 1 to 30. In addition, examples of the alicyclic epoxy compound represented by Formula (i) above include 2,2-bis(3,4-epoxycyclohexyl)propane, 1,2-bis(3,4-epoxycyclohexyl)ethane, 2,3-bis(3,4-epoxycyclohexyl)oxirane, and bis(3,4-epoxycyclohexylmethyl)ether.

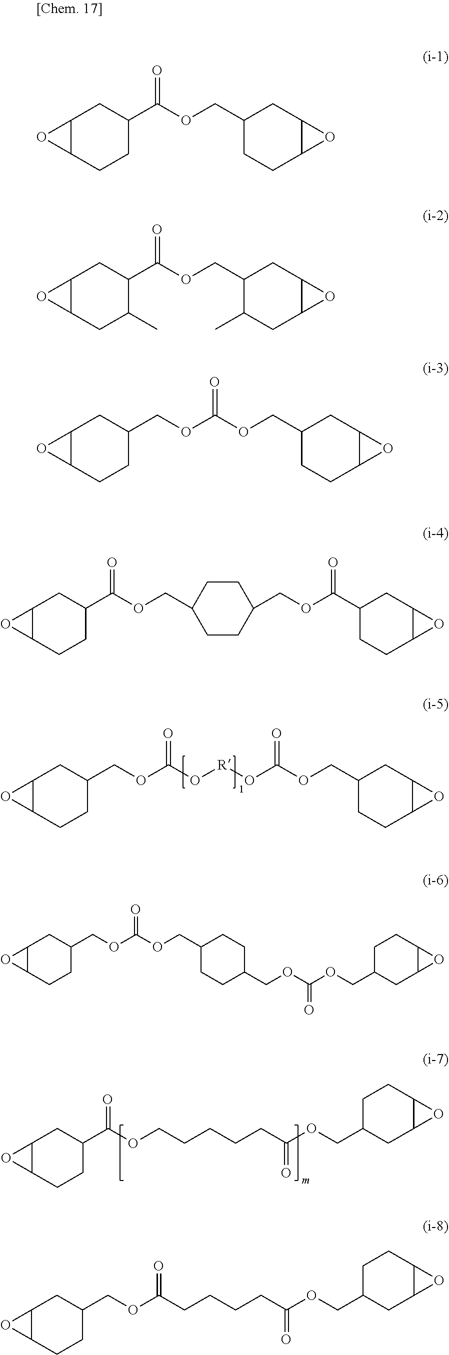

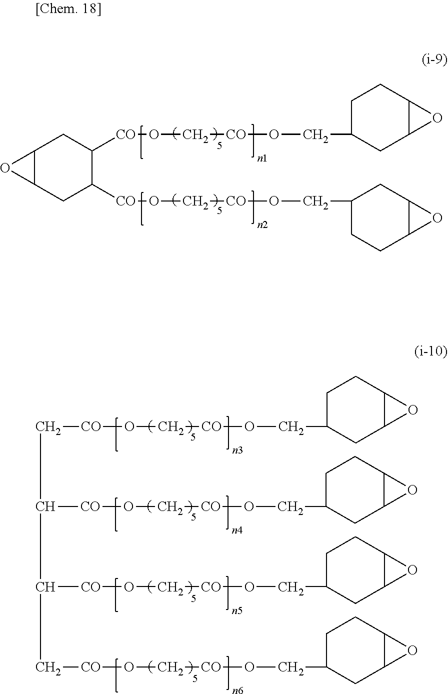

Examples of the compound in which an epoxy group is directly bonded to an alicyclic ring via a single bond include compounds represented by Formula (ii) below.

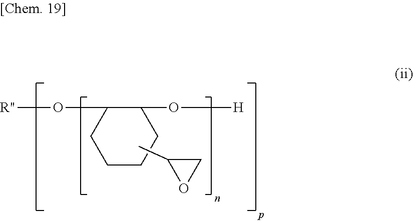

In Formula (ii), R″ is a group (p-valent organic group) resulting from elimination of p hydroxyl groups (—OH) from a structural formula of a p-valent alcohol, wherein p and n each represent a natural number. Examples of the p-hydric alcohol [R″(OH)ₚ] include polyhydric alcohols (such as alcohols having from 1 to 15 carbon atoms), such as 2,2-bis(hydroxymethyl)-1-butanol. Here, p is preferably from 1 to 6, and n is preferably from 1 to 30. When p is 2 or greater, n in each group in parentheses (in the outer parentheses) may be the same or different. Examples of the compound represented by Formula (ii) above specifically include 1,2-epoxy-4-(2-oxiranyl)cyclohexane adduct of 2,2-bis(hydroxymethyl)-1-butanol [for example, such as the trade name “EHPE3150” (available from Daicel Corporation)].

Examples of the compound having an alicyclic ring and a glycidyl ether group in the molecule include glycidyl ethers of alicyclic alcohols (preferably alicyclic polyhydric alcohols). Examples of the glycidyl ethers of alicyclic alcohols include compounds obtained by subjecting a bisphenol A epoxy compound to hydrogenation (hydrogenated bisphenol A epoxy compounds), compounds obtained by subjecting a bisphenol F epoxy compound to hydrogenation (hydrogenated bisphenol F epoxy compounds), hydrogenated biphenol epoxy compounds, hydrogenated phenol novolac epoxy compounds, hydrogenated cresol novolac epoxy compounds, hydrogenated cresol novolac epoxy compounds of bisphenol A, hydrogenated naphthalene epoxy compounds, hydrogenated epoxy compounds of epoxy compounds obtained from trisphenol methane, and hydrogenated epoxy compounds of aromatic epoxy compounds.

Examples of the aromatic epoxy compounds include an epibis type glycidyl ether type epoxy resin obtained by a condensation reaction of a bisphenol and an epihalohydrin; a high molecular weight epibis type glycidyl ether type epoxy resin obtained by further subjecting the above epibis type glycidyl ether type epoxy resin to an addition reaction with the bisphenol described above; a novolac alkyl type glycidyl ether type epoxy resin obtained by subjecting a phenol and an aldehyde to a condensation reaction to obtain a polyhydric alcohol, and then further subjecting the polyhydric alcohol to a condensation reaction with epihalohydrin; and an epoxy compound in which two phenol skeletons are bonded at the 9-position of the fluorene ring, and in which a glycidyl group is bonded directly or via an alkyleneoxy group to an oxygen atom resulting from eliminating a hydrogen atom from a hydroxyl group of each of the two phenol skeletons.

Examples of the aliphatic epoxy compound include glycidyl ethers of a q-valent alcohol, the alcohol including no cyclic structure (q is a natural number); glycidyl esters of monovalent or polyvalent carboxylic acids (for example, such as acetic acid, propionic acid, butyric acid, stearic acid, adipic acid, sebacic acid, maleic acid, and itaconic acid); epoxidized materials of fats and oils including a double bond, such as epoxidized linseed oil, epoxidized soybean oil, and epoxidized castor oil; and epoxidized materials of polyolefins (including polyalkadienes), such as epoxidized polybutadiene.

Examples of the oxetane compound include known or commonly used compounds having one or more oxetane rings in the molecule. As the vinyl ether compound, known or commonly used compounds having one or more vinyl ether groups in the molecule can be used.

A content (blended amount) of the additional cationically curable compound in the curable composition according to an embodiment of the present disclosure relative to a total amount of the polyorganosilsesquioxane according to an embodiment of the present disclosure and the additional cationically curable compound is preferably 50 wt. % or less (for example, from 0 to 50 wt. %), more preferably 30 wt. % or less (for example, from 0 to 30 wt. %), and even more preferably 10 wt. % or less. Setting the content of the additional cationically curable compound to 50 wt. % or less (preferably 10 wt. % or less) tends to further improve the scratch resistance of the cured product. On the other hand, the additional cationically curable compound contained in an amount of 10 wt. % or greater can possibly impart a desired performance to the curable composition and the cured product (for example, fast curing properties and viscosity adjustment to the curable composition).

A content (blended amount) of the vinyl ether compound (preferably a vinyl ether compound having one or more hydroxyl groups in the molecule) in the curable composition according to an embodiment of the present disclosure relative to a total amount of the polyorganosilsesquioxane according to an embodiment of the present disclosure and the additional cationically curable compound is not limited, but is preferably from 0.01 to 10 wt. %, more preferably from 0.05 to 9 wt. %, even more preferably from 1 to 8 wt. %. When the content amount of the vinyl ether compound is controlled to the aforementioned range, the surface hardness of the cured product is further increased, and a cured product with a very high surface hardness tends to be obtained even when the irradiation dose of the active energy rays (for example, ultraviolet rays) is reduced. Preferably, controlling the content of the vinyl ether compound having one or more hydroxyl groups in the molecule to the aforementioned range increases the surface hardness of the cured product and significantly improves the thermal yellowing resistance of the cured product.

The curable composition according to an embodiment of the present disclosure may further include a commonly used additive as an additional optional component. Examples thereof include an inorganic filler, such as precipitated silica, wet silica, fumed silica, calcined silica, titanium dioxide, alumina, glass, quartz, aluminosilicic acid, iron oxide, zinc oxide, calcium carbonate, carbon black, silicon carbide, silicon nitride, and boron nitride; an inorganic filler obtained by treating the above filler with an organosilicon compound, such as an organohalosilane, organoalkoxysilane, and organosilazane; a fine powder of an organic resin, such as a silicone resin, an epoxy resin, and a fluororesin; a filler, such as a conductive metal powder of silver, copper, or the like, a curing auxiliary, a solvent (such as an organic solvent), a stabilizer (such as an antioxidant, an ultraviolet absorber, a light-resistant stabilizer, a heat stabilizer, and a heavy metal inactivator), a flame retardant (such as a phosphorus-based flame retardant, a halogen-based flame retardant, and an inorganic flame retardant), a flame retardant auxiliary, a reinforcing material (such as an additional filler), a nucleating agent, a coupling agent (such as a silane coupling agent), a lubricant, a wax, a plasticizer, a releasing agent, an impact modifier, a hue modifier, a transparentizing agent, a rheology modifier (such as a fluidity modifier), a processability modifier, a colorant (such as a dye and a pigment), an antistatic agent, a dispersant, a surface conditioner (an antifoaming agent, a leveling agent, a welling-up prevention agent), a surface modifier (such as a slipping agent), a matting agent, an antifoaming agent, a foam inhibitor, a deforming agent, an antibacterial agent, a preservative, a viscosity modifier, a thickening agent, a photosensitizer, and a foaming agent. One type alone or two or more types of these additives in combination can be used.

The curable composition according to an embodiment of the present disclosure can be prepared by, but not limited to, agitating and mixing each of the components described above at room temperature or under heating as necessary. Here, the curable composition of the present disclosure can be used as a one-part composition, which contains each component mixed beforehand and is used as is, or alternatively, used as a multi-part (for example, two-part) composition of which two or more components are separately stored and then mixed at a predetermined proportion before use.

The curable composition according to an embodiment of the present disclosure, although not limited, is preferably liquid at normal temperature (approximately 25° C.). More specifically, a liquid of the curable composition according to an embodiment of the present disclosure diluted with a solvent to 20% [preferably a curable composition (solution) having a proportion of methyl isobutyl ketone of 20 wt. %] has a viscosity at 25° C. of preferably from 300 to 20000 mPa·s, more preferably from 500 to 10000 mPa·s, and even more preferably from 1000 to 8000 mPa·s. The curable composition with the viscosity of 300 mPa·s or greater tends to further improve the heat resistance of the cured product. On the other hand, the curable composition with the viscosity of 20000 mPa·s or less facilitates the preparation and handling of the curable composition, and tends to less likely to leave residual bubbles in the cured product. Note that, the viscosity of the curable composition according to an embodiment of the present disclosure is measured using a viscometer (product name “MCR301”, available from Anton Paar GmbH) at a swing angle of 5%, a frequency from 0.1 to 100 (1/s), and a temperature of 25° C.

### Cured Product

By allowing the polymerization reaction of the cationically curable compound (such as the polyorganosilsesquioxane according to an embodiment of the present disclosure) in the curable composition according to an embodiment of the present disclosure to proceed, the curable composition can be cured, and a cured product (may be referred to as a “cured product according to an embodiment of the present disclosure”) can be obtained. The curing method is not particularly limited, and can be appropriately selected from known methods, including, for example, a method of irradiation with active energy rays and/or heating. As the active energy rays, for example, any of infrared rays, visible rays, ultraviolet rays, X-rays, an electron beam, an α-ray, a β-ray, and a γ-ray can be used. Among these, ultraviolet rays are preferred in terms of excellent handling.

Conditions for curing the curable composition according to an embodiment of the present disclosure by irradiation with active energy rays (active energy ray irradiation conditions) are not limited and can be appropriately adjusted according to the type and energy of the active energy rays used in the irradiation and/or the shape and size of the cured product. In the case of irradiation with ultraviolet rays, however, the active energy ray irradiation conditions are, for example, preferably set to approximately from 1 to 1000 mJ/cm². In addition, for example, a high-pressure mercury lamp, an ultra high-pressure mercury lamp, a xenon lamp, a carbon arc, a metal halide lamp, the sunlight, an LED lamp, and a laser can be used for radiation with active energy rays. After radiation with active energy rays, the curing reaction can be further allowed to proceed by further subjecting to a heat treatment (annealing and aging).

Meanwhile, conditions when curing the curable composition according to an embodiment of the present disclosure by heating are not limited but are, for example, preferably from 30 to 200° C., more preferably from 50 to 190° C. The curing time can be appropriately set.

As described above, the curable composition according to an embodiment of the present disclosure can be cured to form a cured product having a high surface hardness and heat resistance as well as excellent flexibility and processability. Therefore, the curable composition according to an embodiment of the present disclosure can be advantageously used as a “curable composition for forming hard coat layer” (sometimes referred to as a “hard coat solution” or a “hard coat agent”) for forming a hard coat layer on a hard coat film. Also, a hard coat film having a hard coat layer formed by using the curable composition according to an embodiment of the present disclosure as the curable composition for forming hard coat layer has flexibility while maintaining a high hardness and a high heat resistance, and is suitable for production and processing with a roll-to-roll process.

### [Hard Coat Film]

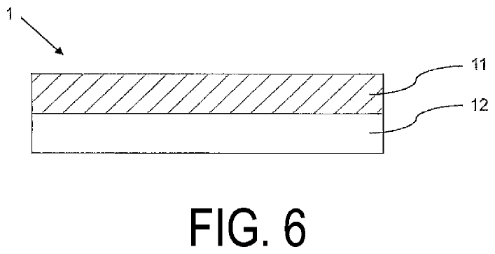

The hard coat film according to an embodiment of the present disclosure is a hard coat film in which a base material and a hard coat layer formed on at least one surface of the base material are laminated; the hard coat layer (cured product layer of the curable composition according to an embodiment of the present disclosure) is formed from the curable composition according to an embodiment of the present disclosure (curable composition for forming hard coat layer). FIG. 6 is a schematic view (cross-sectional view) illustrating the hard coat film of an embodiment of the present disclosure. 1 indicates the hard coat film, 11 indicates the hard coat layer, and 12 indicates the base material.

Note that, the hard coat layer according to an embodiment of the present disclosure in the hard coat film according to an embodiment of the present disclosure may be formed on only one surface (one side) of the base material, or may be formed on both surfaces (both sides) of the base material.

Furthermore, the hard coat layer according to an embodiment of the present disclosure in the hard coat film according to an embodiment of the present disclosure may be formed on only a portion of each surface of the base material, or may be formed over the entirety of each surface of the base material.

The base material in the hard coat film according to an embodiment of the present disclosure is a base material of the hard coat film, and refers to a portion constituting a part other than the hard coat layer according to an embodiment of the present disclosure. The base material is not particularly limited, and a known or commonly used base material can be used, such as a plastic base material, a metal base material, a ceramic base material, a semiconductor base material, a glass base material, a paper base material, a wood base material (wooden base material), and a base material having a surface that is a coated surface. Among these, a plastic base material (a base material constituted of a plastic material) is preferred. Note that, a commercially available product can be also used as the base material such as the plastic base material.

Among the above plastic base materials, a base material having excellent heat resistance, moldability, and mechanical strength is preferably used, and a polyester film (preferably PET or PEN), a cyclic polyolefin film, a polycarbonate film, a TAC film, or a PMMA film is more preferable.

The thickness of the base material is not particularly limited, but can be appropriately selected from a range from 0.01 to 10000 μm, for example.

The hard coat layer according to an embodiment of the present disclosure in the hard coat film according to an embodiment of the present disclosure is a layer that constitutes at least one surface layer in the hard coat film according to an embodiment of the present disclosure, and is a layer (cured product layer) formed from a cured product (resin cured product) obtained by curing the curable composition according to an embodiment of the present disclosure (curable composition for forming hard coat layer).

A thickness of the hard coat layer according to an embodiment of the present disclosure (a thickness of each hard coat layer in a case in which each side of the base material is provided with a hard coat layer according to an embodiment of the present disclosure) is not limited, but is preferably from 1 to 200 μm, more preferably from 3 to 150 μm. Preferably, the hard coat layer according to an embodiment of the present disclosure can maintain a high hardness of the surface (for example, a pencil hardness of H or greater) even when the hard coat layer is thin (for example, a thickness of 5 μm or less). In addition, even if the hard coating layer is thick (for example, a thickness of 50 μm or greater), defects such as crack generation due to curing shrinkage or the like are unlikely to occur, and therefore the pencil hardness can be significantly increased (for example, the pencil hardness can be set to 9H or greater).

A haze of the hard coat layer according to an embodiment of the present disclosure is not particularly limited, but the haze is preferably 1.5% or less, more preferably 1.0% or less, when the thickness of the hard coat layer is 50 μm. In addition, the lower limit of the haze is not particularly limited but is, for example, 0.1%. Setting the haze of the hard coat layer to preferably 1.0% or less tends to render the hard coat layer suitable for, for example, applications requiring very high transparency (such as a surface protection sheet of a display of a touch screen). Here, the haze of the hard coat layer according to an embodiment of the present disclosure can be measured in accordance with JIS K7136.

A total light transmittance of the hard coat layer according to an embodiment of the present disclosure is not particularly limited, but is preferably 85% or greater, more preferably 90% or greater, when the thickness of the hard coat layer is 50 μm. In addition, the upper limit of the total light transmittance is not particularly limited but is, for example, 99%. When the total light transmittance is set to 85% or greater, for example, the present invention tends to be suitable for use, for example, in applications requiring very high transparency (for example, as a surface protection sheet of a display of a touch panel). The total light transmittance of the hard coat layer according to an embodiment of the present disclosure can be measured in accordance with JIS K7361-1.

The hard coat film according to an embodiment of the present disclosure may further have a surface protection film on a surface of the hard coat layer according to an embodiment of the present disclosure.

The hard coat film according to an embodiment of the present disclosure can be produced in accordance with a known or commonly used method for producing a hard coat film. The production method of the hard coat film according to an embodiment of the present disclosure is not limited, but the hard coat film can be produced, for example, by coating at least one surface of the base material with the curable composition according to an embodiment of the present disclosure (curable composition for forming hard coat layer), and then removing, if necessary, the solvent through drying, followed by curing the curable composition (curable composition layer). The conditions for curing the curable composition are not particularly limited, and for example, can be appropriately selected from the above-described conditions when forming the cured product.

Preferably, the hard coat layer according to an embodiment of the present disclosure in the hard coat film according to an embodiment of the present disclosure is a hard coat layer formed from the curable composition according to an embodiment of the present disclosure (curable composition for forming hard coat layer) capable of forming a cured product having excellent flexibility and processability, and thus, the hard coat film according to an embodiment of the present disclosure can be produced by a roll-to-roll process. Producing the hard coat film according to an embodiment of the present disclosure using a roll-to-roll process can significantly increase the productivity of the hard coat film. The method for producing the hard coat film according to an embodiment of the present disclosure using a roll-to-roll process is not limited, and a known or commonly used roll-to-roll production method can be adopted. Examples of the method include a method that includes the following steps (steps A to C), which are performed continuously, as essential steps: unwinding a base material wound in a roll (step A); coating at least one surface of the base material that has been unwound with the curable composition according to an embodiment of the present disclosure (curable composition for forming hard coat layer), and then removing, if necessary, the solvent through drying, followed by curing the curable composition (curable composition layer) to form a hard coat layer according to an embodiment of the present disclosure (step B); and then winding the resulting hard coat film into a roll once again (step C). In addition, the method may also include steps in addition to steps A to C.

A thickness of the hard coat film according to an embodiment of the present disclosure is not limited, and can be appropriately selected from a range from 1 to 10000 μm.

A pencil hardness of a surface of the hard coat layer according to an embodiment of the present disclosure in the hard coat film according to an embodiment of the present disclosure is not limited, but is preferably 5H or greater, more preferably 6H or greater, and even more preferably 7H or greater. Here, the pencil hardness can be evaluated according to the method described in JIS K5600-5-4.

A haze of the hard coat film according to an embodiment of the present disclosure, although not limited, is preferably 1.5% or less, more preferably 1.0% or less. In addition, the lower limit of the haze is not particularly limited but is, for example, 0.1%. Setting the haze of the hard coat film to preferably 1.0% or less tends to render the hard coat film suitable for, for example, applications requiring very high transparency (such as a surface protection sheet of a display of a touch screen). The haze of the hard coat film according to an embodiment of the present disclosure can be easily controlled to the above range, for example, by using the transparent base material described above as the base material. Here, the haze can be measured according to JIS K7136.

A total light transmittance of the hard coat film according to an embodiment of the present disclosure, although not limited, is preferably 85% or greater, more preferably 90% or greater. In addition, the upper limit of the total light transmittance is not particularly limited but is, for example, 99%. Setting the total light transmittance of the hard coat film to 90% or greater tends to render the hard coat film suitable for, for example, applications requiring very high transparency (such as a surface protection sheet of a display of a touch screen). The total light transmittance of the hard coat film according to an embodiment of the present disclosure can be easily controlled to the above range, for example, by using the transparent base material described above as the base material. Here, the total light transmittance can be measured according to JIS K7361-1.

The hard coat film according to an embodiment of the present disclosure has a high hardness and flexibility while maintaining a high heat resistance and can be produced and processed by a roll-to-roll process, and therefore has a high level of quality and excellent productivity. Preferably, when a surface protection film is provided on a surface of the hard coat layer according to an embodiment of the present disclosure, punching processability is also excellent. Therefore, the present invention can be preferably used for any application that requires such properties. The hard coat film according to an embodiment of the present disclosure can be used, for example, as a surface protection film on various products, or as a surface protection film for a member or component of various products, or can also be used as a constituent material for various products, members of various products, or components of various products. Examples of the above products include display devices, such as liquid crystal displays and organic EL displays; input devices, such as touch panels; solar cells; various consumer electronics; various electrical and electronic products; various electrical and electronic products of portable electronic terminals (for example, gaming devices, personal computers, tablets, smartphones, and mobile phones); and various optical devices. Examples of aspects in which the hard coat film according to an embodiment of the present disclosure is used as a constituent material for various products, members of various products, or components of various products include an aspect in which the hard coat film is used in a touch screen and constitutes a laminate including the hard coat film and a transparent conductive film.

The cured product obtained by curing the curable composition according to an embodiment of the present disclosure is not only excellent in terms of surface hardness, heat resistance, flexibility, and processability, which have been described above, but also in terms of adhesiveness and adhesion to an adherend. As such, the curable composition according to an embodiment of the present disclosure can be also advantageously used as an adhesive (sometimes referred to as an “composition for an adhesive”). An adhesive obtained by using the curable composition according to an embodiment of the present disclosure as a composition for an adhesive can be turned into, by way of curing, an adhesive member having excellent surface hardness, heat resistance, flexibility, processability, adhesiveness, and adhesion. For example, when the curable composition according to an embodiment of the present disclosure contains a photocationic polymerization initiator as a curing catalyst, the adhesive can be used as a photocurable adhesive, and when the curable composition according to an embodiment of the present disclosure contains a thermal cationic polymerization initiator, the adhesive can be used as a thermosetting adhesive.

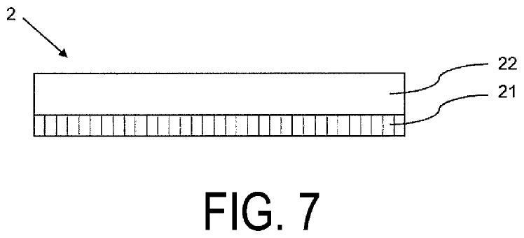

By using the curable composition according to an embodiment of the present disclosure (composition for an adhesive), it is possible to obtain an adhesive sheet (sometimes referred to as an “adhesive sheet according to an embodiment of the present disclosure”) having at least a base material and an adhesive layer on the base material, the adhesive layer being a layer of the curable composition according to an embodiment of the present disclosure (sometimes referred to as a “adhesive layer according to an embodiment of the present disclosure”). FIG. 7 is a schematic view (cross-sectional view) illustrating the adhesive sheet of an embodiment of the present disclosure. 2 indicates the adhesive sheet, 21 indicates the adhesive layer, and 22 indicates the base material.

The adhesive sheet according to an embodiment of the present disclosure may have a form of a sheet or a sheet-like form, such as a film form, a tape form, and a plate form. The adhesive sheet according to an embodiment of the present disclosure, although not limited, can be obtained by applying the curable composition according to an embodiment of the present disclosure to a base material and then drying if necessary, for example. The application method is not limited, and a known or commonly used means can be adopted. Furthermore, the means or conditions of drying are also not limited; the conditions can be set to those that facilitate the removal of volatile components such as a solvent as much as possible, and a known or commonly used means can be adopted.

The adhesive sheet according to an embodiment of the present disclosure may be a single-sided adhesive sheet having an adhesive layer on only one side of the base material, or may be a double-sided adhesive sheet having an adhesive layer on both sides of the base material. When the adhesive sheet according to an embodiment of the present disclosure is a double-sided adhesive sheet, at least the adhesive layer on one side may be the adhesive layer according to an embodiment of the present disclosure, and the adhesive layer on the other side may be either the adhesive layer according to an embodiment of the present disclosure or another adhesive layer.

The base material in the adhesive sheet according to an embodiment of the present disclosure can be a known or commonly used base material (a base material used in an adhesive sheet), and is not limited. Examples of the base material include a plastic base material, a metal base material, a ceramic base material, a semiconductor base material, a glass base material, a paper base material, a wood base material, and a base material having a coated surface; specific examples include those that are similar to the examples of the base material in the hard coat film according to an embodiment of the present disclosure. Also, the base material in the adhesive sheet according to an embodiment of the present disclosure may be a so-called release liner, and can be, for example, one that is similar to the surface protective film in the hard coat film according to an embodiment of the present disclosure. Note that, the adhesive sheet according to an embodiment of the present disclosure may have only one layer of the base material, or may have two or more layers the base material. Moreover, a thickness of the base material is not limited, and can be appropriately selected within a range of, for example, from 1 to 10000 μm.

The adhesive sheet according to an embodiment of the present disclosure may have only one layer of the adhesive layer according to an embodiment of the present disclosure, or may have two or more types thereof Moreover, a thickness of the adhesive layer according to an embodiment of the present disclosure is not limited, and can be appropriately selected within a range of, for example, from 0.1 to 10000 μm. The same applies to another adhesive layer (an adhesive layer other than the adhesive layer according to an embodiment of the present disclosure).

The adhesive sheet according to an embodiment of the present disclosure may have another layer (such as an intermediate layer or an undercoat) in addition to the base material and the adhesive layer.

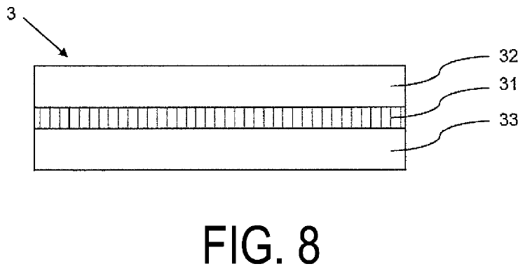

By using the curable composition according to an embodiment of the present disclosure (composition for an adhesive), it is possible to obtain a laminate (sometimes referred to as a “laminate according to an embodiment of the present disclosure”) that includes three or more layers (at least three layers). The at least three layers include two adherend layers, and an adhesive layer disposed between the two adherend layers. The adhesive layer serves as a layer that bonds the adherend layers with each other. The adhesive layer is a layer of the cured product of the curable composition according to an embodiment of the present disclosure. This adhesive layer is also referred to as an “adhesive layer according to an embodiment of the present disclosure”. FIG. 8 is a schematic view (cross-sectional view) illustrating the adhesive sheet of an embodiment of the present disclosure. 3 indicates the laminate, 31 indicates the adhesive layer (cured product), and 32 and 33 indicate the adherend layers.

The laminate according to an embodiment of the present disclosure may be obtained typically, but not limitatively, by forming the adhesive layer according to an embodiment of the present disclosure on one of the two adherend layers, applying the other adherend layer to the formed adhesive layer, and then subjecting the resulting article to, for example, light irradiation and/or heating to cure the adhesive layer according to an embodiment of the present disclosure. The formation of the adhesive layer may be performed in a manner similar to that of the adhesive layer in the adhesive sheet according to an embodiment of the present disclosure. In a case in which the laminate according to an embodiment of the present disclosure is prepared using the adhesive sheet according to an embodiment of the present disclosure that is a single-sided adhesive sheet, the laminate may be obtained by applying the adhesive sheet according to an embodiment of the present disclosure to the adherend layer, and subjecting the resulting article to light irradiation and/or heating to cure the adhesive layer according to an embodiment of the present disclosure in the adhesive sheet. In the resulting laminate, the base material in the adhesive sheet according to an embodiment of the present disclosure corresponds to an adherend layer. Furthermore, in a case in which the laminate according to an embodiment of the present disclosure is prepared using the adhesive sheet according to an embodiment of the present disclosure that is a double-sided adhesive sheet including a release liner as the base material, the laminate may be obtained by applying the adhesive sheet according to an embodiment of the present disclosure to one adherend layer, removing the release liner to expose the adhesive layer, applying the other adherend layer to the exposed adhesive layer, and subjecting the resulting article typically to light irradiation and/or heating to cure the adhesive layer according to an embodiment of the present disclosure. However, the method for producing the laminate according to an embodiment of the present disclosure is not limited to the methods mentioned above.

The adherend in the laminate according to an embodiment of the present disclosure is not limited, and examples thereof include those that are similar to the base material in the hard coat film according to an embodiment of the present disclosure. Note that, the laminate according to an embodiment of the present disclosure may include only two adherend layers or include three or more adherend layers. The thickness of the adherend layer is not limited and may be selected as appropriate within a range of, for example, from 1 to 100000 μm. The adherend does not have to have a layer form in a strict sense.

The laminate according to an embodiment of the present disclosure may have only one layer of the adhesive layer according to an embodiment of the present disclosure, or may have two or more types thereof Moreover, a thickness of the adhesive layer according to an embodiment of the present disclosure is not limited, and can be appropriately selected within a range of, for example, from 0.1 to 10000 μm.

The laminate according to an embodiment of the present disclosure may have another layer (for example, an intermediate layer, an undercoat, or another adhesive layer) in addition to the adherend and the adhesive layer according to an embodiment of the present disclosure.

The curable composition according to an embodiment of the present disclosure (composition for an adhesive) can be used not only in the preparation of the adhesive sheet according to an embodiment of the present disclosure and the laminate according to an embodiment of the present disclosure, but also in other various applications for bonding desired articles (such as parts) with each other.

Each aspect disclosed in the present specification can be combined with any other feature disclosed herein.

Note that each of the configurations, combinations thereof, and the like in each of the embodiments are an example, and various additions, omissions, substitutions, and other changes may be made as appropriate without departing from the spirit of the present disclosure. The present disclosure is not limited by the embodiment and is limited only by the claims.

### EXAMPLES

Hereinafter, the present disclosure will be described in more detail based on examples, but the present disclosure is not limited by these examples. The number average molecular weight and the polydispersity index of the product were measured under the following GPC conditions. The ¹H-NMR spectrum of the product was measured under the following conditions.

Further, the area % of the cage-type silsesquioxane represented by Compositional Formula (1) above (T₉) of the product and the area % of the cage-type silsesquioxane having the constituent unit represented by Compositional Formula (I-2) above (T₁₀) of the product were measured under the following HPLC-ELSD conditions, and a fraction corresponds to the largest peak on the chart obtained from HPLC-ELSD was collected. The ratio of the T3 units to the T2 units [T3 units/T2 units] of the product was measured by ²⁹Si-NMR spectroscopic analysis using Brucker AVANCE (600 MHz). Furthermore, the mass spectrometry of the fraction was performed using a quadrupole time-of-flight mass spectrometer (product name “Xevo G2-XS QTof”, available from Waters Corporation).

### GPC Conditions

Measuring apparatus: Product name “GPC Semi-micro System” (available from Shimadzu Corporation)

Detector: RI detector (available from Shoko Science Co., Ltd.)

Column: KF-G4A (guard column), KF-602, and KF-603 (available from Shoko Science Co., Ltd.)

Flow rate: 0.6 mL/min

Measurement temperature: 40° C.

Measurement time: 13 min

Injection volume: 20 μL

Eluent: THF, sample concentration from 0.1 to 0.2 wt. %

Molecular weight: Calibrated with standard polystyrene

### ¹H-NMR Conditions

Measuring apparatus: Product name “ECA-500 (500 MHz)” (available from JEOL Ltd.)

Solvent: Deuterochloroform

Cumulative number of scans: 16

Measurement temperature: 25° C.

### HPLC-ELSD Conditions

Measuring apparatus: Alliance 2695 (available from Waters Corporation)

Detector: PL-ELS2100 (available from Polymer Laboratories)

Detection conditions: ELSD (Evap: 70° C., Neb: 50° C., Gas: 1.60)

Column: YMC-Triart PFP 3 μm 4.6φ×150 mm+SunShell RP Guard Filter

Eluent: (A) ultrapure water, (B) THF/ACN=4/6

Gradient conditions: (A)/(B)=30/70 (0 min)→30 min→(A)/(B)=0/100 (10 min)

Flow rate: 1 mL/min

Column temperature: 25° C.

Injection volume: 10 μL

Analysis time: 30 min

### Example 1: Production of Epoxy Group-Containing Polyorganosilsesquioxane

99.2 parts by weight of 2-(3,4-epoxycyclohexyl)ethyltrimethoxysilane (hereinafter referred to as “EMS”) and 0.806 parts by weight of phenyltrimethoxysilane (hereinafter referred to as “PMS”) were dissolved in 400 parts by weight of methyl isobutyl ketone (MIBK) under a stream of nitrogen in a 1000 milliliter flask (reaction vessel) equipped with a thermometer, a stirrer, a reflux condenser, and a nitrogen inlet tube, and 73.2 parts by weight of water was added. The mixture was heated to 60° C. in a nitrogen atmosphere, then 11.2 parts by weight of a 5% potassium carbonate aqueous solution was added dropwise over 5 minutes. After reacting for 5 hours at 60° C., MIBK and a 5% NaCl aqueous solution were added to the mixture to perform liquid separation, and an organic layer was separated. The organic layer was washed with water six times, then the solvent was distilled off under reduced pressure, resulting in a colorless and transparent product. An analysis under the GPC conditions mentioned above found that the resulting product had a number average molecular weight (Mn) of 1561 and a polydispersity index (Mw/Mn) of 1.52. Further, when the resulting product was analyzed under the HPLC-ELSD conditions mentioned above, the peak at a retention time of approximately 5.8 seconds in the chromatogram corresponds to T₉, while the peak at a retention time of approximately 7.5 seconds corresponds to T₁₀. From the value of area % of each peak with respect to the total areas of peaks, it was calculated that the area % of T₉, the cage-type silsesquioxane represented by Compositional Formula (1), was 25.3%, the area % of T₁₀, the cage-type silsesquioxane having the constituent unit represented by Compositional Formula (I-2), was 4.45%, and T₉/T₁₀ was 5.69. The ratio of the T3 units to the T2 units [T3 units/T2 units] calculated from the ²⁹Si-NMR spectrum of the product was 6.00.

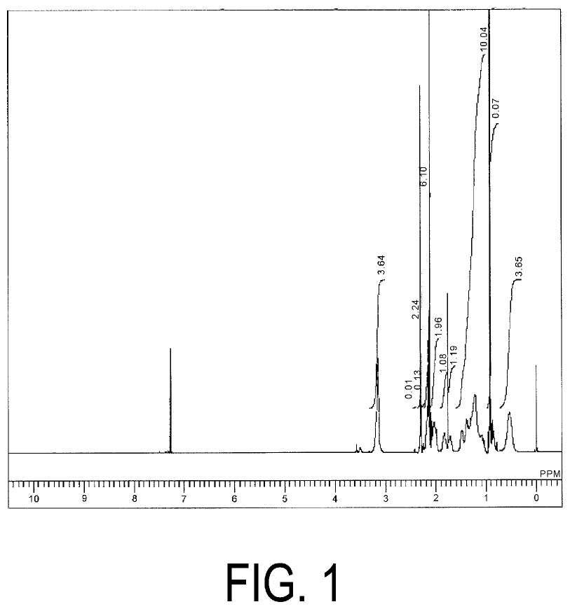

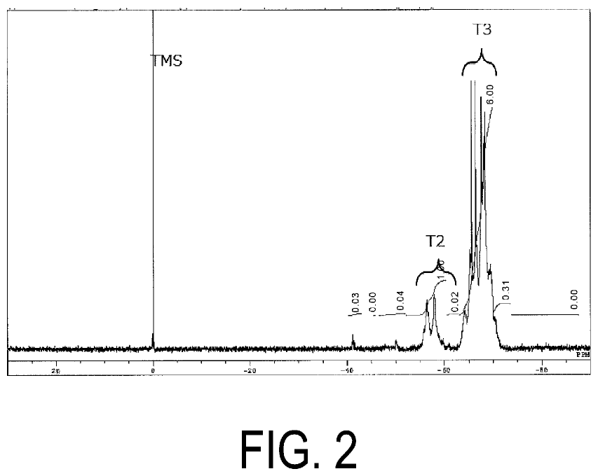

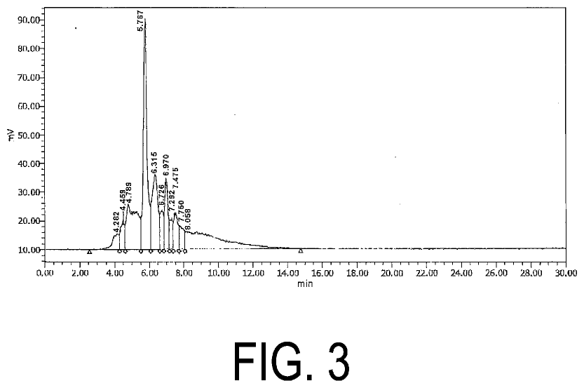

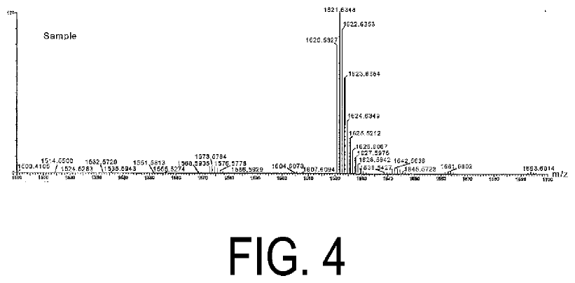

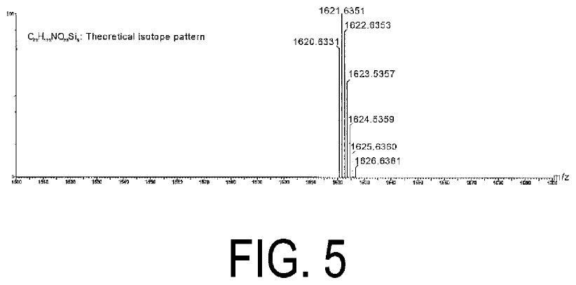

FIG. 1 is the ¹H-NMR chart of the resulting product, FIG. 2 is the ²⁹Si-NMR chart of the resulting product, and FIG. 3 is the chromatogram resulted from the HPLC-ELSD analysis of the resulting product. Also, a fraction of the resulting product corresponds to the peak at a retention time of approximately 5.8 seconds under the HPLC-ELSD conditions was collected. FIG. 4 is the result of mass spectrometry (ESI-MS spectrum) of the fraction collected. FIG. 5 is the theoretical isotope pattern of the fraction collected, assuming that the molecular formula is C₇₂H₁₂₂NO₂₃Si₉ [corresponding to Compositional Formula (1) in which all R¹s are 2-(3,4-epoxycyclohexyl)ethyl groups]. A peak at a retention time of approximately 5.8 seconds can be identified as T₉ by comparison with the theoretical isotope pattern.

Examples 2 to 12 and Comparative Examples 1 and 2 Syntheses were carried out in the same manner as in Example 1 except that the catalysts, the types and amounts of the reaction solvents, the amounts of water, and the reaction temperatures were changed to the values presented in Table 1. Table 1 presents the catalysts, the reaction solvents and the amounts thereof (parts by weight), the amounts of water (parts by weight), the reaction temperatures (° C.), the number average molecular weights (Mn), the molecular weight distributions, the values of area % of the cage-type silsesquioxane represented by Compositional Formula (1) above (T₉), the values of area % of the cage-type silsesquioxane having the constituent unit represented by Compositional Formula (I-2) above (T₁₀), and the values of T₉/T₁₀. Note that in Table 1, the reaction solvent DMAc is dimethylacetamide, the reaction solvent THF is tetrahydrofuran, the reaction solvent IPA is isopropyl alcohol, the catalyst DBU is 1,8-diazabicyclo[5.4.0]undec-7-ene, and the catalyst TMAOH is trimethylammonium hydroxide.

### Production of Hard Coat Film

Methyl isobutyl ketone (MIBK) (available from Kanto Chemical Co., Inc.) was added to each of the polyorganosilsesquioxanes obtained in Examples 1 to 12 and Comparative Examples 1 and 2 above to adjust the concentration of polyorganosilsesquioxane to 60 parts by weight; then, each mixture was used to prepare a mixed solution containing 0.5 parts by weight of a leveling agent (product name “S-243”, available from AGC Seimi Chemical Co., Ltd.) and 1 part by weight of a photocationic polymerization initiator (product name “CPI-210S”, available from San-Apro Ltd.), resulting in a curable composition.

Each of the resulting curable compositions was applied on a PEN (polyethylene naphthalate) film [product name “TEONEX” (trade name), available from Teijin DuPont Films Co., Ltd., thickness of 50 μm] to give the resulting hard coat layer after curing a thickness of 30 or 10 μm. Then, the film with the curable composition applied was left in an oven at 120° C. for 10 minutes (pre-baked), and then irradiated with ultraviolet rays (irradiance of 120 W/cm², speed of 4.5 M/min, available from Ushio Inc., product name “UVH-0251C-2200”). Finally, a heat treatment (aging) was performed at 120° C. for 30 minutes to prepare a film having each of the hard coat layers (hard coat film).

### Evaluation

The hard coat films obtained in Examples 1 to 12 and Comparative Examples 1 and 2 above were evaluated for bending resistance and pencil hardness by the following methods. The evaluation results are presented in Table 1.

### Bending Resistance: Cylindrical Mandrel Method

The bending resistance of the hard coat films (thickness 10 μm) obtained above was evaluated by testing in accordance with JIS K5600-5-1 using a cylindrical mandrel. Mandrels with diameters of 2, 3, and 5 mm were used, and the test was conducted with the hard coat layer facing inward (“infold”) or outward (“outfold”). When the hard coat layers were in the “infold” position, the tests were performed using a mandrel with a diameter of 2 mm; the hard coat layers were evaluated as “good” when cracks were not observed, or “poor” when cracks were observed. When the hard coat layers were in the “outfold” position, the tests were performed using a mandrel with a diameter of 3 mm and/or 5 mm; the hard coat layers were evaluated as “good” when cracks were not observed, or “poor” when cracks were observed. The results are shown in Table 1.

### Surface Hardness: Pencil Hardness

The pencil hardness of the surface (the surface of the hard coat layer) of the hard coat films (thickness 30 μm) obtained above was evaluated in accordance with JIS K5600-5-4, with a load of 750 g. The results are shown in Table 1.

### Heat Resistance: 5% Weight Loss Temperature (T_{d5})

The T_{d5} (5% weight loss temperature) of the product was measured by TGA (thermogravimetric analysis) under the following measurement conditions.

### (Measurement Conditions)

Measuring apparatus: TG-DTA 6200/Hitachi High-Tech Science

Atmosphere: N₂

Temperature range: From 25° C. to 550° C.

Rate of temperature increase: 10° C./min

Sample tray: Al

TABLE 1

| | | | Amount of | Reaction | | Molecular | T₉ |
|---|---|---|---|---|---|---|---|
| | | Solvent | Water/Part | Temperature/ | | Weight | Specific |
| | Catalyst | (parts by weight) | by Weight | ° C. | Mn | Distribution | Area % |
| Example 1 | K₂CO₃ | MIBK (400) | 73.2 | 60 | 1561 | 1.52 | 25.3 |
| Example 2 | K₂CO₃ | MIBK (400) | 73.2 | 70 | 1540 | 1.72 | 23.0 |
| Example 3 | K₂CO₃ | MIBK (400) | 73.2 | 80 | 1513 | 1.86 | 19.6 |
| Example 4 | K₂CO₃ | THF (400) | 73.2 | 50 | 1331 | 1.63 | 26.7 |
| Example 5 | K₂CO₃ | Acetone (320) | 73.2 | 50 | 1815 | 2.08 | 8.47 |
| | | MIBK (80) | | | | | |
| Example 6 | K₂CO₃ | Acetone (240) | 73.2 | 50 | 1625 | 1.95 | 11.7 |
| | | MIBK (160) | | | | | |
| Example 7 | K₂CO₃ | IPA (400) | 73.2 | 50 | 1905 | 2.02 | 13.5 |
| Example 8 | K₂CO₃ | Acetone (400) | 146 | 50 | 2842 | 1.96 | 5.75 |
| Example 9 | K₂CO₃ | Acetone (400) | 22.0 | 50 | 1972 | 2.05 | 10.3 |
| Example 10 | K₂CO₃ | Acetone (400) | 44.0 | 50 | 2093 | 2.07 | 10.4 |
| Example 11 | KOH | MIBK (400) | 73.2 | 60 | 1631 | 1.78 | 15.6 |
| Example 12 | K₂CO₃ | Acetone (700) | 73.2 | 50 | 1695 | 1.74 | 15.1 |
| Comparative | K₂CO₃ | Acetone (100) | 73.2 | 50 | 5927 | 4.66 | 1.43 |
| Example 1 | | | | | | | |
| Comparative | TMAOH | MIBK (100) | 17.2 | 50 | 2244 | 2.30 | 3.85 |
| Example 2 | | | | | | | |

| | T₁₀ | | | Mandrel Test | | | |
|---|---|---|---|---|---|---|---|
| | Specific | | Pencil | Infold | Outfold | | |
| | Area % | T₉/T₁₀ | hardness | 2 mmφ | 5 mmφ | 3 mmφ | T_{d5}/° C. |
| Example 1 | 4.45 | 5.69 | 9H | Good | Good | Poor | 360.6 |
| Example 2 | 7.86 | 2.93 | 9H | Good | Good | Poor | 358.1 |
| Example 3 | 13.0 | 1.52 | 7H | Good | Good | Poor | 356.5 |
| Example 4 | 7.32 | 3.65 | 7H | Good | Good | Poor | 364.9 |
| Example 5 | 8.47 | 1.00 | 7H | Good | Good | Poor | — |
| Example 6 | 9.32 | 1.25 | 8H | Good | Good | Good | — |
| Example 7 | 6.75 | 2.00 | 6H | Good | Good | Poor | — |
| Example 8 | 13.2 | 0.435 | 6H | Good | Good | Poor | 371.3 |
| Example 9 | 11.1 | 0.928 | 7H | Good | Good | Poor | 360.3 |
| Example 10 | 4.85 | 2.15 | 9H | Good | Good | Poor | 368.1 |
| Example 11 | 10.5 | 1.48 | 9H | Good | Good | Poor | — |
| Example 12 | 14.8 | 1.02 | 9H | Good | Good | Poor | 367.4 |
| Comparative | 1.67 | 0.856 | 4H | Good | Good | Poor | 339.9 |
| Example 1 | | | | | | | |
| Comparative | 3.87 | 0.994 | 4H | Good | Good | Poor | — |
| Example 2 | | | | | | | |

Hereinafter, variations of the invention according to the present disclosure will be described.

[Appendix 1] A polyorganosilsesquioxane containing a cage-type silsesquioxane represented by Compositional Formula (1) below, in which, when the polyorganosilsesquioxane is analyzed using a liquid chromatography-evaporative light scattering detector, a peak area % of the cage-type silsesquioxane represented by Compositional Formula (1) below is 5% or greater (preferably 6% or greater, more preferably 7% or greater, more preferably 8% or greater, more preferably 9% or greater, more preferably 10% or greater, more preferably 12% or greater, more preferably 14% or greater, more preferably 16% or greater, more preferably 18% or greater, more preferably 20% or greater, more preferably 22% or greater, more preferably 24% or greater, more preferably 26% or greater, more preferably 28% or greater, more preferably 30% or greater, more preferably 32% or greater, more preferably 34% or greater, more preferably 36% or greater, more preferably 38% or greater, more preferably 40% or greater, and even more preferably 45% or greater), with respect to a peak area of all components.

[R¹SiO_{3/2}]₈[R¹SiO_{2/2}(OR^{c})]₁ Formula (1)

where in Formula (1), each R¹ is independently a group containing a polymerizable functional group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom, while at least one R¹ is a group containing a polymerizable functional group; R^{c} represents an alkyl group having from 1 to 4 carbons or a hydrogen atom.

[Appendix 2] The polyorganosilsesquioxane according to Appendix 1, wherein the peak area % is 90% or less (preferably 80% or less).

[Appendix 3] The polyorganosilsesquioxane according to Appendix 1 or 2, wherein, when the polyorganosilsesquioxane is analyzed using a liquid chromatography-evaporative light scattering detector (LC-ELSD), a ratio of the peak area % of the cage-type silsesquioxane represented by the Compositional Formula (1) above (T₉) to a peak area % of a cage-type silsesquioxane having a constituent unit represented by Compositional Formula (I-2) below (T₁₀), or a ratio of T₉/T₁₀, is 0.4 or greater (preferably 0.5 or greater, more preferably 0.6 or greater, more preferably 0.7 or greater, more preferably 0.8 or greater, more preferably 0.9 or greater, more preferably 1 or greater, more preferably 1.2 or greater, more preferably 1.4 or greater, more preferably 1.6 or greater, more preferably 1.8 or greater, more preferably 2 or greater, more preferably 2.2 or greater, more preferably 2.4 or greater, more preferably 2.6 or greater, more preferably 2.8 or greater, more preferably 3 or greater, more preferably 3.5 or greater, more preferably 4 or greater, more preferably 4.5 or greater, and even more preferably 5 or greater).

[R^{a}SIO_{3/2}]₁₀ (I-2)

where R^{a} in Compositional Formula (I-2) represents a group containing a polymerizable functional group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom.

[Appendix 4] The polyorganosilsesquioxane according to Appendix 3, wherein the ratio of peak area % (T₉/T₁₀) is 10 or less (preferably 9 or less).

[Appendix 5] The polyorganosilsesquioxane according to any one of Appendices 1 to 4, wherein a number of groups containing a polymerizable functional group in R¹ in Compositional Formula (1) above is from 3 to 9 (preferably from 5 to 9, more preferably from 7 to 9, and even more preferably 9).

[Appendix 6] The polyorganosilsesquioxane according to any one of Appendices 1 to 5, wherein the group containing a polymerizable functional group contains a cationically polymerizable functional group (preferably an epoxy group, an oxetane group, a vinyl ether group, or a vinyl phenyl group).

[Appendix 7] The polyorganosilsesquioxane according to any one of Appendices 1 to 6, wherein the group containing a polymerizable functional group contains a radically polymerizable functional group (preferably a (meth)acryloyloxy group, a (meth)acrylamide group, a vinyl group, or a vinylthio group).

[Appendix 8] The polyorganosilsesquioxane according to any one of Appendices 1 to 7, wherein the polyorganosilsesquioxane contains an epoxy group or a (meth)acryloxy group as the polymerizable functional group.

[Appendix 9] The polyorganosilsesquioxane according to any one of Appendices 1 to 8, wherein in T₉ above, a proportion of the group containing a polymerizable functional group to the total of R¹ is 30% or greater (preferably 50% or greater, more preferably 80% or greater).

[Appendix 10] The polyorganosilsesquioxane according to any one of Appendices 1 to 9, wherein the group containing a polymerizable functional group is:

a group represented by Formula (1a)

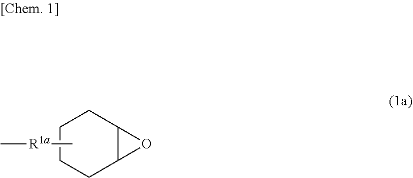

where R^{1a} represents a linear or branched alkylene group;

a group represented by Formula (1b)

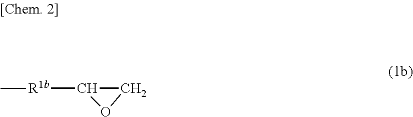

where R^{1b} represents a linear or branched alkylene group;

a group represented by Formula (1c)

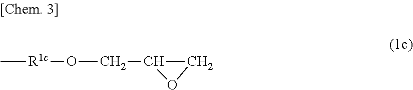

where R^{1c} represents a linear or branched alkylene group; or

a group represented by Formula (1d)

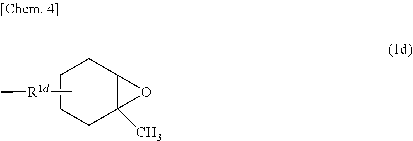

where R^{1d} represents a linear or branched alkylene group.

[Appendix 11] The polyorganosilsesquioxane according to Appendix 10, wherein R^{1a}, R^{1b}, R^{1c}, and R^{1d} in Formulas (1a), (1b), (1c), and (1d) above are a linear or branched alkylene group (preferably a linear alkylene group having from 1 to 4 carbons or a branched alkylene group having 3 or 4 carbons, more preferably an ethylene group, a trimethylene group, or a propylene group, and even more preferably an ethylene group or a trimethylene group).

[Appendix 12] The polyorganosilsesquioxane according to any one of Appendices 1 to 11, wherein a molar ratio of a constituent unit represented by Formula (I) below (T3 unit) to a constituent unit represented by Formula (II) below (T2 unit) [constituent unit represented by Formula (I)/constituent unit represented by Formula (II); T3 unit/T2 unit] is 1 or greater (preferably 2 or greater, more preferably 3 or greater, more preferably 4 or greater, more preferably 5 or greater, more preferably 6 or greater, more preferably 7 or greater, more preferably 8 or greater, more preferably 9 or greater, and even more preferably is 10 or greater).

[R^{a}SiO_{3/2}] (I)

where in Formula (I), R^{a} represents a group containing a polymerizable functional group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom.

[R^{b}SiO_{2/2}(OR^{c})] (II)

where in Formula (II), R^{b} represents a group containing a polymerizable functional group, a substituted or unsubstituted aryl group, a substituted or unsubstituted aralkyl group, a substituted or unsubstituted cycloalkyl group, a substituted or unsubstituted alkyl group, or a substituted or unsubstituted alkenyl group; R^{c} represents a hydrogen atom or an alkyl group having from 1 to 4 carbons.

[Appendix 13] The polyorganosilsesquioxane according to Appendix 12, wherein the molar ratio of the T3 unit to the T2 unit (T3 unit/T2 unit) is 500 or less (preferably 100 or less, more preferably 50 or less, more preferably 40 or less, more preferably 30 or less, more preferably 25 or less, more preferably 20 or less, more preferably 18 or less, and even more preferably 16 or less).

[Appendix 14] The polyorganosilsesquioxane according to any one of Appendices 1 to 13, wherein a number average molecular weight (Mn), determined by gel permeation chromatography and calibrated with standard polystyrene, is from 1000 to 50000 (preferably from 1100 to 40000, more preferably from 1200 to 30000).

[Appendix 15] The polyorganosilsesquioxane according to any one of Appendices 1 to 14, wherein a polydispersity index (Mw/Mn), determined by gel permeation chromatography and calibrated with standard polystyrene, is from 1.0 to 4.0 (preferably from 1.1 to 3.0, more preferably from 1.2 to 2.5).

[Appendix 16] The polyorganosilsesquioxane according to any one of Appendices 1 to 15, wherein a 5% weight loss temperature (T_{d5}) in an air atmosphere is 330° C. or higher (for example, from 330 to 450° C., preferably 340° C. or higher, and more preferably 350° C. or higher).

[Appendix 17] A curable composition containing the polyorganosilsesquioxane described in any one of Appendices 1 to 16.

[Appendix 18] The curable composition according to Appendix 17, wherein a content (blended amount) of the polyorganosilsesquioxane with respect to a total amount (100 wt. %) of the curable composition excluding solvent is from 70 to 100 wt. % (preferably from 80 to 99 wt. %, more preferably from 90 to 99.5 wt. %).

[Appendix 19] The curable composition according to Appendix 17 or 18, wherein a content of the polyorganosilsesquioxane with respect to a total amount (100 wt. %) of a cationically curable compound is from 70 to 100 wt. % (preferably from 75 to 98 wt. %, more preferably from 80 to 95 wt. %).

[Appendix 20] The curable composition according to any one of Appendices 17 to 19, wherein the curable composition contains a curing catalyst.

[Appendix 21] The curable composition according to Appendix 20, wherein the curable composition contains a photopolymerization initiator or a thermal polymerization initiator as the curing catalyst.

[Appendix 22] The curable composition according to Appendix 20 or 21, wherein the curable composition contains a cationic polymerization initiator as the curing catalyst.

[Appendix 23] The curable composition according to Appendix 22, wherein the cationic polymerization initiator is a photocationic polymerization initiator or a thermal cationic polymerization initiator.

[Appendix 24] The curable composition according to Appendix 23, wherein the photocationic polymerization initiator is one or more selected from the group consisting of a sulfonium salt, an iodonium salt, a selenium salt, an ammonium salt, a phosphonium salt, and a salt of a transition metal complex ion and an anion.

[Appendix 25] The curable composition according to Appendix 23, wherein the thermal cationic polymerization initiator is one or more selected from the group consisting of an arylsulfonium salt, an aryliodonium salt, an allene-ion complex, a quatemary ammonium salt, an aluminum chelate, and a boron trifluoride amine complex.

[Appendix 26] The curable composition according to any one of Appendices 20 to 25, wherein a content of the curing catalyst with respect to 100 parts by weight of a total amount of the cationically curable compound is from 0.01 to 3.0 parts by weight (preferably from 0.05 to 3.0 parts by weight, more preferably from 0.1 to 1.0 parts by weight, and even more preferably from 0.3 to 1.0 parts by weight).

[Appendix 27] The curable composition according to any one of Appendices 17 to 26, wherein the curable composition contains an additional cationically curable compound in addition to the polyorganosilsesquioxane.

[Appendix 28] The curable composition according to Appendix 27, wherein the additional cationically curable compound is one or more compounds selected from the group consisting of an epoxy compound other than the polyorganosilsesquioxane, an oxetane compound, and a vinyl ether compound.

[Appendix 29] The curable composition according to Appendix 28, wherein the epoxy compound is an alicyclic epoxy compound, an aromatic epoxy compound, or an aliphatic epoxy compound.

[Appendix 30] The curable composition according to any one of Appendices 27 to 29, wherein a content of the additional cationically curable compound with respect to a total amount of the polyorganosilsesquioxane and the additional cationically curable compound is 50 wt. % or less (preferably 30 wt. % or less, more preferably 10 wt. % or less).

[Appendix 31] The curable composition according to any one of Appendices 17 to 30, wherein the curable composition is liquid at normal temperature (approximately 25° C.).

[Appendix 32] The curable composition according to any one of Appendices 17 to 31, wherein a liquid of the curable composition diluted with a solvent to 20% [preferably a curable composition (solution) having a proportion of methyl isobutyl ketone of 20 wt. %] has a viscosity at 25° C. from 300 to 20000 mPa·s (preferably from 500 to 10000 mPa·s, more preferably from 1000 to 8000 mPa·s).

[Appendix 33] The curable composition according to any one of Appendices 17 to 32, wherein the curable composition is a curable composition for forming hard coat layer.

[Appendix 34] A use of the curable composition described in any one of Appendices 17 to 32 as a curable composition for forming hard coat layer.

[Appendix 35] The curable composition according to any one of Appendices 17 to 32, wherein the curable composition is a curable composition for an adhesive.

[Appendix 36] A use of the curable composition described in any one of Appendices 17 to 32 as a curable composition for an adhesive.

[Appendix 37] A cured product of the curable composition described in any one of Appendices 17 to 33 or Appendix 35.

[Appendix 38] A hard coat film in which a base material and a hard coat layer formed on at least one surface of the base material are laminated, the hard coat layer being a cured product of the curable composition described in Appendix 33.

[Appendix 39] The hard coat film according to Appendix 38, wherein the base material is a plastic base material, a metal base material, a ceramic base material, a semiconductor base material, a glass base material, a paper base material, a wood base material, or a base material having a coated surface.

[Appendix 40] The hard coat film according to Appendix 38 or 39, wherein the hard coat layer has a thickness from 1 to 200 μm (preferably from 3 to 150 μm).

[Appendix 41] The hard coat film according to any one of Appendices 38 to 40, wherein a haze is 1.5% or less (preferably 1.0% or less) when the hard coat layer has a thickness of 50 μm.

[Appendix 42] The hard coat film according to any one of Appendices 38 to 41, wherein the haze is 0.10% or greater when the hard coat layer has a thickness of 50 μm.

[Appendix 43] The hard coat film according to any one of Appendices 38 to 42, wherein a total light transmittance is 85% or greater (preferably 90% or greater) when the hard coat layer has a thickness of 50 μm.

[Appendix 44] The hard coat film according to any one of Appendices 38 to 43, wherein the hard coat film has a surface protective film on a surface of the hard coat layer.

[Appendix 45] The hard coat film according to any one of Appendices 38 to 44, wherein the surface of the hard coat layer has a pencil hardness of 5H or greater (preferably 6H or greater, more preferably 7H or greater).

[Appendix 46] An adhesive sheet having a base material and an adhesive layer on the base material, the adhesive layer being a layer of the curable composition described in Appendix 35.

[Appendix 47] A use of the curable composition described in Appendix 35 as the adhesive layer in an adhesive sheet having a base material and an adhesive layer on the base material.

[Appendix 48] A laminate having three or more layers that include two adherend layers and an adhesive layer between the two adherend layers, the adhesive layer being a layer of a cured product of the curable composition described in Appendix 35.

### INDUSTRIAL APPLICABILITY

The polyorganosilsesquioxane according to an embodiment of the present disclosure can be used as a raw material for a hard coat film or an adhesive sheet.

### REFERENCE SIGNS LIST

1 Hard coat film
11 Hard coat layer
12 Base material
2 Adhesive sheet
21 Adhesive layer
22 Base material
3 Laminate
31 Adhesive layer (cured product)
32, 33 Adherend layer

1. A polyorganosilsesquioxane comprising a cage-type silsesquioxane represented by Compositional Formula (1), wherein, when the polyorganosilsesquioxane is analyzed using a liquid chromatography-evaporative light scattering detector, a peak area % of the cage-type silsesquioxane represented by Compositional Formula (1) is 5% or greater with respect to a peak area of all components,
[R¹SiO_{3/2}]₈[R¹SiO_{2/2}(OR^{c})]₁ Formula (1)
wherein each R¹ is independently a group containing a polymerizable functional group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom; at least one R¹ is a group containing a polymerizable functional group; and R^{c} represents an alkyl group having from 1 to 4 carbons or a hydrogen atom.

2. The polyorganosilsesquioxane according to claim 1, wherein the group containing a polymerizable functional group is:
a group represented by Formula (1a): 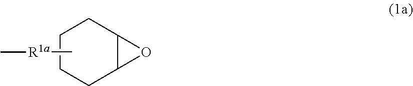
wherein R^{1a} represents a linear or branched alkylene group;
a group represented by Formula (1b): 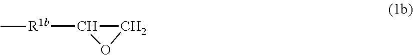
wherein R^{1b} represents a linear or branched alkylene group;
a group represented by Formula (1c): 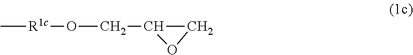
wherein R^{1c} represents a linear or branched alkylene group; or
a group represented by Formula (1d): 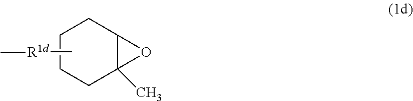
wherein R^{1d} represents a linear or branched alkylene group.

3. The polyorganosilsesquioxane according to claim 1, wherein in the cage-type silsesquioxane represented by Compositional Formula (1), a proportion of the group containing a polymerizable functional group to the total of R¹ is 30% or greater.

4. The polyorganosilsesquioxane according to claim 1, wherein a molar ratio of a constituent unit represented by Formula (I) to a constituent unit represented by Formula (II) [constituent unit represented by Formula (I)/constituent unit represented by Formula (II)] is from 1 to 500,
[R^{a}SiO_{3/2}] (I)
wherein R^{a} represents a group containing a polymerizable functional group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom,
[R^{b}SiO_{2/2}(OR^{c})] (II)
wherein R^{b} represents a group containing a polymerizable functional group, a substituted or unsubstituted aryl group, a substituted or unsubstituted aralkyl group, a substituted or unsubstituted cycloalkyl group, a substituted or unsubstituted alkyl group, or a substituted or unsubstituted alkenyl group; and R^{c} represents a hydrogen atom or an alkyl group having from 1 to 4 carbons.

5. The polyorganosilsesquioxane according to claim 1, wherein a number average molecular weight is from 1000 to 50000.

6. The polyorganosilsesquioxane according to claim 1, wherein a polydispersity index (weight average molecular weight/number average molecular weight) is from 1.0 to 4.0.

7. The polyorganosilsesquioxane according to claim 1, wherein a 5% weight loss temperature (T_{d5}) is 330° C. or higher.

8. A curable composition comprising the polyorganosilsesquioxane described in claim 1.

9. The curable composition according to claim 8, further comprising a curing catalyst.

10. The curable composition according to claim 9, wherein the curing catalyst is a photopolymerization initiator or a thermal polymerization initiator.

11. The curable composition according to claim 8, wherein the curable composition is a curable composition for forming a hard coat layer.

12. The curable composition according to claim 8, wherein the curable composition is a composition for an adhesive.

13. A cured product of the curable composition described in claim 8.

14. A hard coat film in which a base material and a hard coat layer formed on at least one surface of the base material are laminated, the hard coat layer being a cured product of the curable composition described in claim 11.

15. An adhesive sheet comprising a base material and an adhesive layer on the base material,
the adhesive layer being a layer of the curable composition described in claim 12.

16. A laminate comprising three or more layers that include two adherend layers and an adhesive layer between the two adherend layers,
the adhesive layer being a layer of a cured product of the curable composition described in claim 12.
